(19) United States
(12) Patent Application Publication
(10) Pub. No.: US 2005/0086290 A1
(43) Pub. Date: Apr. 21, 2005

(54) Method and system to provide expert support with a customer interaction system

(76) Inventors: Robert Joyce, San Jose, CA (US); Prabhuram Mohan, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/687,956

(22) Filed: Oct. 17, 2003

(51) Int. Cl. G06F 15/16; G06F 17/30

(52) U.S. Cl. 709/202; 707/3

(57) ABSTRACT

A method and apparatus to is provided to respond to a customer query received at a customer interaction system. The method includes communicating at least one expert group to an agent; receiving a selection from the agent that identifies an expert group from the at least one expert group, the selection triggering a first immediate message that includes a request for assistance from the expert group; identifying at least one expert that is associated with the expert group; and establishing an immediate message connection between the at least one expert and the agent, wherein the immediate message connection enables the exchange of immediate messages between the at least one expert and the agent so the agent may respond to the customer query.

### FIELD OF THE INVENTION

The present invention relates generally to the field of customer interaction systems, more specifically the utilization of the customer interaction system to provide access to expert support.

### BACKGROUND OF THE INVENTION

Customers will use different media types to communicate with agents of an organization. For instance customers may place a telephone call, initiate a web chat, or send an email to the organization. In response, the agent will provide service or support, usually by communicating via the media type chosen by the customer. An agent that responds to a customer in real time (e.g., telephone call, web chat, etc.) has the added complication of responding with quality information in the least amount of time possible. In such instances, the agent's task may be difficult because the agent does not have the knowledge or expertise to answer the customer's question fully or satisfy the customer needs completely. In such instances, the agent may place the customer on hold while the agent seeks to obtain expert counsel or ask the customer to call back later or promise to call back the customer when the desired information is obtained. In some instances the agent may elect to give the customer his best guess or may provide the customer with less than optimal information. For example, if the shipping expert is available, the agent may be able to give the customer the expected order arrival date within a day or two. Without access to the expert, the agent may promise the customer only that the order will arrive within 2 to 3 weeks.

### SUMMARY OF THE INVENTION

A method to respond to a customer query received at a customer interaction system. The method includes communicating at least one expert group to an agent; receiving a selection from the agent that identifies an expert group from the at least one expert group, the selection triggering a first immediate message that includes a request for assistance from the expert group; identifying at least one expert that is associated with the expert group; and establishing an immediate message connection between the at least one expert and the agent, wherein the immediate message connection enables the exchange of immediate messages between the at least one expert and the agent so the agent may respond to the customer query.

Another method to respond to a customer query received at a customer interaction system. The method include communicating a choice of preferences to an agent; receiving a selection of preferences from the agent, the selection of preferences triggering a first immediate message that includes a request for assistance from at least one expert; identifying at least one expert based on the selection of preferences; and establishing an immediate message connection between the at least one expert and the agent, wherein the immediate message connection enables the exchange of immediate messages between the at least one expert and the agent so the agent may respond to the customer query.

A method to respond to a requester query received at a customer interaction system. The method includes communicating at least one expert group to a requester; receiving a selection from the requester that identifies an expert group from the at least one expert group, the selection triggering a first immediate message that includes a request for assistance from the expert group; identifying at least one expert that is associated with the expert group; and establishing an immediate message connection between the at least one expert and the requester, wherein the immediate message connection enables the exchange of immediate messages between the at least one expert and the requester so the requester may receive a response to the requester query.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating hardware and software components, according to an exemplary embodiment of the present invention;

FIG. 2 is a block diagram illustrating an agent work area, according to an exemplary embodiment of the present invention;

FIG. 3 is a block diagram illustrating software and hardware components, according to an exemplary embodiment of the present invention;

FIG. 4, including FIGS. 4A and 4B, is an entity relationship diagram illustrating entity relationships, according to an exemplary embodiment of the present invention;

FIG. 5, including FIGS. 5A, 5B and 5C, are a flow charts illustrating a method, according to an exemplary embodiment of the present invention, to respond to a customer or a requester query received at a customer interaction system;

FIG. 6 illustrates a method, according to an exemplary embodiment of the present invention, to establish a connection;

FIG. 7 illustrates a method, according to an exemplary embodiment of the present invention, to process notice;

FIG. 8 illustrates a method, according to an exemplary embodiment of the present invention, to log an instant message and capture statistics for an instant message communicated by an agent to an expert group;

FIG. 9 illustrate a method, according to an exemplary embodiment of the present invention, to log an instant message and collect statistics for an instant message communicated by an expert to an expert group and an agent;

FIG. 10 illustrates a method, according to an exemplary embodiment of the present invention, to interrupt an expert;

FIG. 11-15 illustrate user interface screens; and

FIG. 16 illustrates a diagrammatic representation of an exemplary machine.

### DETAILED DESCRIPTION

A method and system to respond to a customer query that is received at a customer interaction system and processed with an immediate or instant message service are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a customer interaction system that receives a customer query in the form of an email, web chat, immediate or instant message, telephone call or any other media type that is subsequently routed to an agent. The agent typically services the customer query without assistance; however, if the agent cannot fully answer a query posed by the customer then the agent may request assistance from an expert before responding to the customer query.

Responsive to the agent receiving such a customer query, the agent may select an appropriate expert group and optionally an expert name from a display appearing on a desktop machine associated with the agent. The request triggers the communication of an immediate message, in the exemplary form of an instant message, to the customer interaction system that identifies one or more candidate experts from the expert group selected by the agent. The customer interaction system may identify the one or more candidate experts by utilizing a number of different methods including a fixed or configurable algorithm implemented with customized business logic in the form of a workflow that is programmed from an administrative client machine. In addition, the customer interaction system monitors each experts status via the instant message service to inform the agent whether any experts are online and to enable the Customer Interaction System to decide which experts will be offered the opportunity to accept a request for assistance. Subsequent to the identification of candidate experts, the customer interaction system communicates an instant message to each of the experts that includes a request for assistance. In one embodiment the customer interaction system rings a single candidate expert at a time and waits for a response before ringing the next candidate expert (serial ring). In another embodiment the customer interaction system rings all of the identified experts at the same time (parallel ring) by multicasting the same instant message that includes a request for assistance to each of the candidate experts. In both embodiments, the candidate expert responds by accepting, rejecting or ignoring the request. In regard to the parallel ring embodiment, once a candidate expert accepts a request for assistance, all other candidate experts are subsequently notified that the request has been satisfied and thereby are precluded from accepting. After consulting with the expert(s), the agent utilizes the obtained advice to respond to the customer's query.

In another embodiment, the agent may consult with multiple experts. Thus, in response to the first acceptance, the customer interaction system will establish an immediate or instant message session that includes the first expert and the agent. In response to additional acceptances the customer interaction system will add additional experts to the already established instant message session thereby enabling consultation between the agent and a multitude of experts.

In another embodiment of the invention, an expert may be interrupted to provide assistance to an agent. As previously described, a candidate expert must have an online status before a request for assistance is communicated to the expert. The present embodiment enables interruption of an expert that does not have an online status but nevertheless has a status that indicates he or she may be interrupted (e.g., a status indicating Busy, On the phone, etc.).

Another aspect of the invention substitutes a principal for an agent. As previously described the agent requests assistance from an expert on behalf of a customer. In the present aspect, the principal or requester stands in the place of the agent with the exception that the requester requests assistance, in the exemplary form of a requester query, for his or her own benefit and not the benefit of the customer.

### Architecture

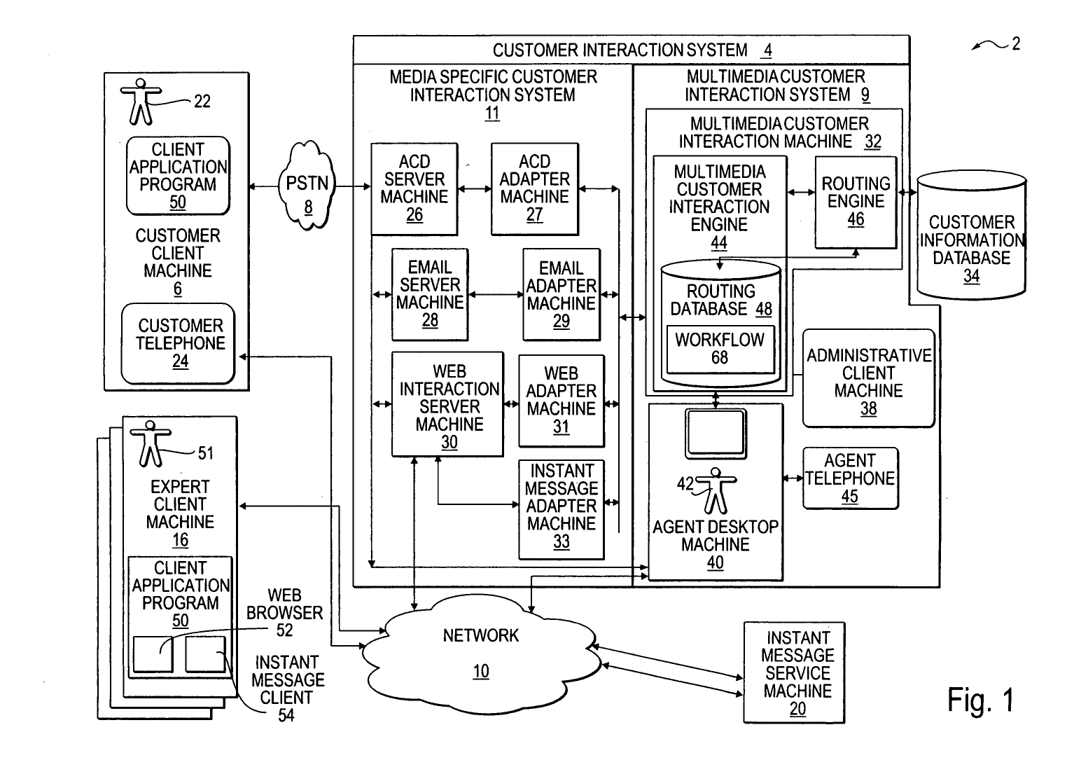

FIG. 1 is a block diagram illustrating the system 2, according to an exemplary embodiment of the present invention, to process a customer or requester query received at a customer interaction system 4 and processed with an instant message service. The system 2 includes the customer interaction system 4, the customer client machine 6, a Public Switched Transport Network (PSTN) 8, a network 10, an expert client machine 16, and an immediate or the instant message service machine 20.

The customer client machine 6 is coupled to the customer interaction system 4 by the PSTN 8 and the network 10 and coupled to the instant message service machine 20 by the network 10. Each customer client machine 6 is associated with a customer 22 and a customer telephone 24. The customer 22, seated at the customer client machine 6 and next to the customer telephone 24, may utilize the customer telephone 24 or services available through the customer client machine 6 (e.g., email, web, instant messaging, etc.) to connect to and interact with an agent (not shown) dedicated to a specific media type or an agent 42 dedicated to multiple media types.

The customer interaction system 4 includes the media specific customer interaction system 11 and the multimedia customer interaction system 9. The media specific customer interaction system 11 includes an automatic call distribution (ACD) server machine 26, an email server machine 28, a web interaction server machine 30, an ACD adapter machine 27, an email adapter machine 29, a web adapter machine 31 and an instant message adapter machine 33. Each media specific customer interaction machine includes a media specific queue utilized to queue media specific calls that originate from the customer 22 and are queued for allocation to an available agent. Further, each media specific customer interaction machine services calls for one or more exemplary interaction types in the form of media types. For example, the ACD server machine 26 services calls in the form of telephone calls; the email server machine 28 services calls in the form of emails; and the web interaction server machine 30 services calls in the form of web interaction requests and/or instant message requests that are forwarded to the instant message adapter machine 33. The web interaction server machine 30 responds to the web interaction request by providing web chat and web navigational services (e.g., one party, the caller or agent, may use a browser to navigate to a web page on the WWW while a remote browser displays the same web page to the other party). Adapters in the form of the ACD adapter machine 27, the email adapter machine 29, the web adapter machine 31 and the instant message adapter machine 33 each provide connectivity and application independence between the respective media specific interaction machine (e.g., ACD, Email, Web Interaction) and the multimedia customer interaction system 9. Consequently, core software in the multimedia customer interaction system 9 may remain unchanged notwithstanding the addition or revision of software components in the media specific customer interaction system 11. For example, each adapter may include an adapter layer that provides a common set of messages across all media types (e.g., telephone, email, web interaction, instant messaging, etc.) preserving respective application independence. In the exemplary embodiment, messages are bundled into the Simple Object Access Protocol “SOAP” message format and communicated over HTTP; however, communication may be facilitated with any agreed protocol. Further, the exemplary embodiment uses extensible markup language (XML) to create files in the Web Services Description Language (WSDL) format that define the services provided. Other embodiments may use other markup languages and file formats.

The multimedia customer interaction system 9 includes a multimedia customer interaction machine 32 that is coupled to a customer information database 34, an administrative client machine 38, and the agent desktop machine 40 where the agent 42 and the agent telephone 45 are located. The multimedia customer interaction machine 32 includes a multimedia customer interaction engine 44, a routing engine 46 and a routing database 48.

The routing database 48 includes a static routing database and a dynamic routing database. The static routing database includes persistent information in the form of agent configuration information, expert configuration information, expert group configuration information, etc.. The dynamic routing database facilitates expedient access to highly dynamic data and frequently used applications. Examples of frequently used applications include workflows 68 and other applications that may be served up on demand. Examples of highly dynamic data include agent status information (e.g., available, unavailable, status of current task, etc.), expert status information (e.g., online, accept request for assistance, etc).

The administrative client machine 38 is utilized to access a presentation framework for a user to configure objects in the customer interaction system 4. The administrative client machine 38 provides read and write access to objects including instant messaging screennames, expert screennames, agent screennames, expert group configuration data, expert configuration data, workflows 68 and other object as will be discussed further below.

In one embodiment an administrator utilizes the administrative client machine 38 to configure the expert groups and/or experts that are accessible by each agent. Thus, each agent may view and request assistance from a predetermined list of expert groups as determined by the administrator (e.g., the administrator may configure experts based on his or her role in an organization). Consequently, an agent would not be able to request assistance from an expert group or an expert that did not appear on the agent's screen thus preventing misuse and overuse of expert resources.

In yet another embodiment the administrator may define session attributes that are selected by an agent and associated to the instant message session. For example, the administrator may define a session attribute such as a geographical region that may be associated with choices that include south, east, west and north. Subsequently, the agent would be prompted to enter the customers geographical region before requesting expert support by selecting the proper region from a pull down menu. Capture of instant message metadata in an instant message log table would include the geographical region chosen by the agent.

The routing engine 46 executes exemplary business logic in the form of the workflows 68 in response to receiving a set of parameters and an event. The routing engine 46 utilizes parameters and an event type to identify and execute the appropriate workflow 68. The routing engine 46, as directed by the workflow 68, accesses the customer information database 34 and the routing database 48 to obtain information that is utilized to identify experts that may respond to a request for assistance from an agent.

The expert client machine 16 is coupled to the web interaction server machine 30, the agent desktop machine 40 and the instant message service machine 20 via the network 10. The expert client machine 16 utilizes instant message services as provided by the instant message service machine 20 to communicate with the agent desktop machine 40 and the web interaction server machine 30. The expert client machine 16 includes a client application program 50 that may take the form of a web browser 52 or an instant messaging client 54. An expert 51 at the expert client machine 16 may utilize the web browser 52 to load the instant messaging client 54. In one embodiment, the expert 51 may initiate an instant message session from the instant messaging client 54. In another embodiment, the expert 51 may initiate the instant session by selecting a link that is displayed by the web browser 52 and launching the instant messaging client 54. In most embodiments, the expert registers with one or more instant message services by identifying themselves with an instant message screenname that is recognized and processed by the customer interaction system 4. Further, the expert 51 may be affiliated with the enterprise that operates the customer interaction system 4 or with an external organization (e.g., partners, suppliers, vendors, etc. to the enterprise).

The instant message service enables the real time exchange of text messages between two users that are identified by screen names. For example, an instant messaging service may take the form of the America Online Instant Messenger (AIM®) provided by America Online, a Time Warner Company of Delaware, N.J.; or, MSN Messenger® provided by Microsoft of Redmond, Wash. and the National Broadcasting Company of New York, N.Y.; or the Yahoo's! Messenger® provided by Yahoo Inc. of Santa Clara, Calif.

The network 10 may be embodied as Internet, a LAN, a WAN, PSTN, Frame Relay, ATM, satellite communications, wireless communications, combinations thereof, or any other network equipment or protocol that enables electronic communication between the above described network entities.

In an exemplary embodiment, the allocation of a customer call to an agent is performed as follows. The customer 22 initiates a call from the customer client machine 6 (e.g., email, web interaction, instant message, etc.) or the customer telephone 24 that is serviced by the respective media specific customer interaction machine based upon the media types as selected by the customer 22. The respective media specific customer interaction machine receives the call and attempts to assign the call to an agent that is coupled to the media specific interaction machine (not shown). If the call cannot be assigned to the agent that is coupled to the media specific interaction machine, the call is queued at the media specific interaction machine and a request is communicated to the multimedia customer interaction system 9. The multimedia customer interaction system 9 attempts to allocate the call to an available agent 42 that is coupled to the multimedia customer interaction machine 32. In the event that the call cannot be allocated to the agent 42 the call is queued at a unified queue where it waits for an available agent (e.g., an agent coupled to the media specific customer interaction system 11 or an agent coupled to the multimedia customer interaction system 9).

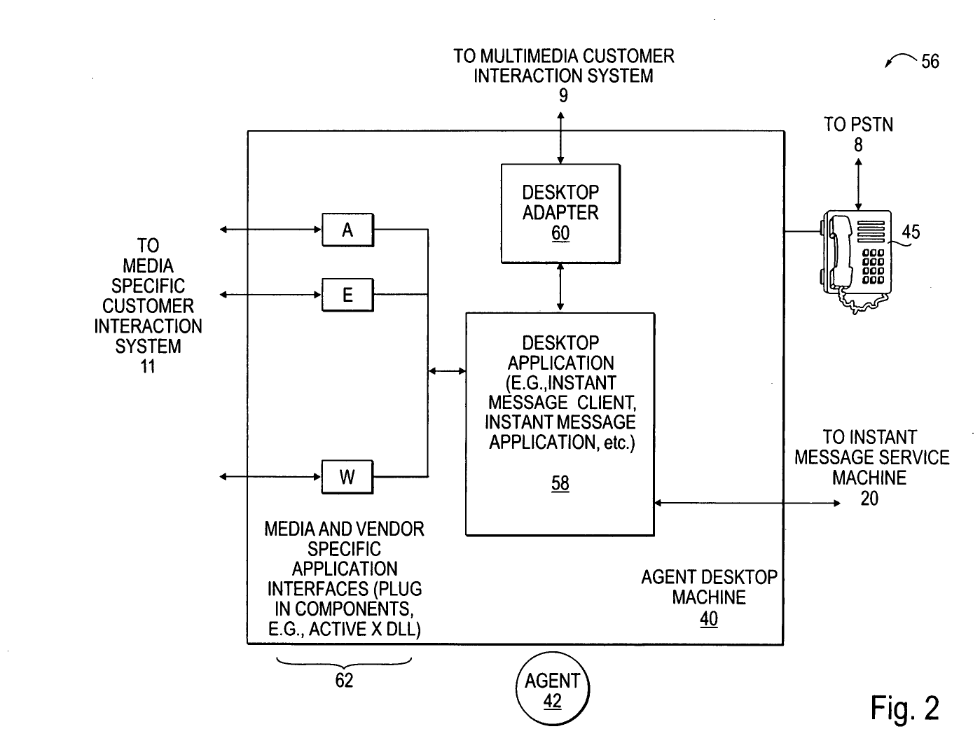

FIG. 2 is a block diagram illustrating an agent work area 56, according to an exemplary embodiment of the present invention. The agent 42 is positioned in front of the agent desktop machine 40 that includes a communication module in the form of an exemplary desktop application 58. The desktop application 58 may be embodied as an instant message client or an instant message application, etc.. The agent 42 may utilize the desktop application to communicate instant messages with the expert 51 at the expert client machine 16 or the customer 22 at the customer client machine 6 (the instant message client may be provided by an instant messaging service such as America Online Instant Messenger (AIM®), MSN Messenger® Yahoo's! Messenger®, etc.). Further, the agent 42 may communicate with the customer 22 via other media types including but not limited to, email, web-chat, voice communication, etc.

The agent work area 56 may also be embodied on a client machine (not shown) that would include a browser (thin client) that connects via HFTP or HTTPS to the agent desktop machine 40 (thick client) which would include the desktop adapter 60 and other components as illustrated in FIG. 2.

In one embodiment, the agent 42 may communicate with the expert 51 by utilizing the same instant message client and instant message service that is utilized by the expert 51. In another embodiment, the agent 42 may communicate with the expert 51 by utilizing an instant message client and instant message service that is different from instant message client and instant message service that is utilized by the expert 51. In yet another embodiment, the desktop application 58 may provide a single consistent instant messaging interface to the agent 42 that is capable of utilizing multiple instant messaging clients and services. In most embodiments, the agent registers with one or more instant message services by identifying themselves with an instant message screenname that is recognized and processed by the customer interaction system 4.

The desktop application 58 utilizes the desktop adapter 60 to communicate that the agent is available for work to the multimedia customer interaction system 9 and/or to receive a task available message from the multimedia customer interaction system 9 that a call (e.g., email, telephone, instant message, web-chat, etc.) is available. The desktop application 58 responds to receiving a task available message from the multimedia customer interaction system 9 by utilizing an application interface 62 that corresponds to a specific media type and vendor to retrieve the corresponding task (e.g., call) from the media specific customer interaction system 11. The application interface 62 may take the form of a plug-in component, such as an Active-X control included in a dynamic link library (DLL) which is a library of executable functions or data that can be used by a Window® application. An Active-X control is software that can be automatically downloaded and executed by a web browser. Active-X is not a programming language, but rather a set of rules for how applications should share information. An Active-X control can be developed in a variety of languages including C, C++, Virtual Basic and Java.

The agent work area 56 also includes the agent telephone 45 which may be connected to the PSTN 8 and/or the agent desktop machine 40.

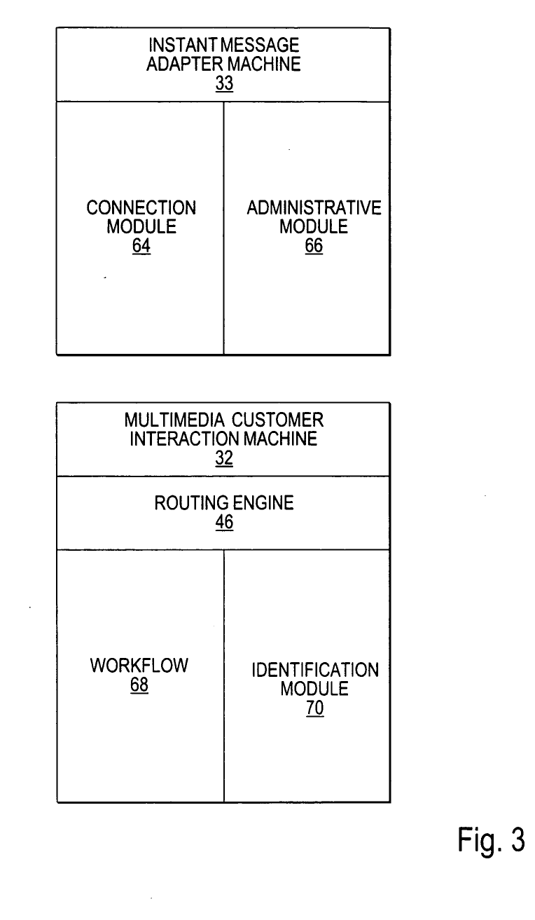

FIG. 3 is a block diagram illustrating software and hardware components, according to an exemplary embodiment of the present invention. The instant message adapter machine 33 includes a connection module 64 and an administrative module 66.

The connection module 64 establishes instant message connections, maintains instant message connections and updates various tables in the routing database. The connection module 64 establishes instant message connections by registering all expert group screennames with one or more instant message services upon initialization. Thus, the connection module 64, in the instant message adapter machine 33, will receive all instant messages communicated to the expert group screenname.

The connection module 64 maintains instant message connections by acting as a proxy whereby the connection module 64 receives an instant message addressed to the expert group screenname and forwards it to members of the expert group.

The administrative module 66 logs the contents of instant messages and associated metadata (e.g., sender and receiver screennames, session attribute choices, topics, subjects, etc.). Further the administrative module 66 captures and stores related statistical information (e.g., number of instant messages processed by an agent, number of instant messages received, number of experts required to log an instant message, etc.) to tables in the routing database 48.

In an alternate embodiment, the connection module 64 and the administrative module 66 may execute on the multimedia customer interaction machine 32.

The multimedia customer interaction machine 32 includes the routing engine 46 that includes an identification module 70 that executes one or more workflows 68. The workflow 68 may contain customizable business logic utilized to identify at least one expert. The workflow 68 may be invoked in response to an agent requesting expert assistance and is created from the administrative client machine 38. The workflow 68 includes programmable business logic that identifies a candidate expert(s) in response to the agent selecting an expert group or in response to an agent selecting an expert group and a specific expert name or in response to the agent selecting preferences that might characterize an expert. The workflow utilizes static information (e.g., expert groups, expert language skills, expert skill levels, expert skill levels as related to products, expert skill levels as related to manufacturer, expert skill levels as related to product comparisons, etc.) and dynamic information (e.g., expert with the greatest time since last request serviced, expert with the quickest response time, etc.) maintained in the routing database 48. Further the workflow may utilize information in the customer information database 34 (e.g., total quantity of customer purchases, recent quantity of customer purchase, assistance previously requested, etc.) to select candidate experts.

In an alternate embodiment, the workflow 68 and the identification module 70 may execute on the instant message adapter machine 33.

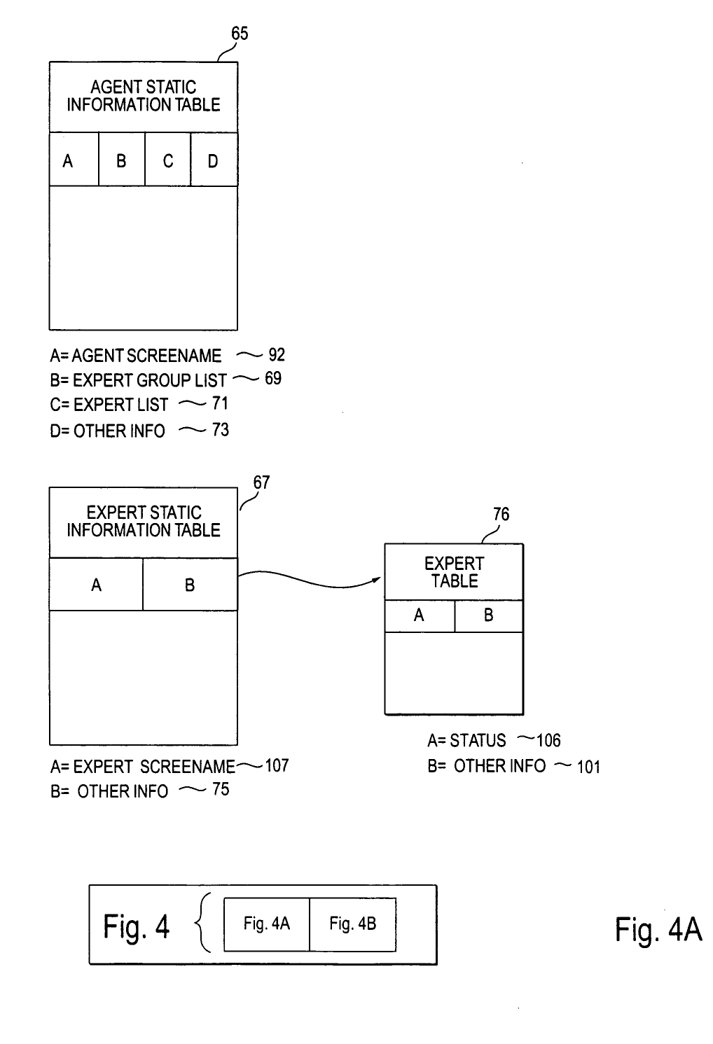

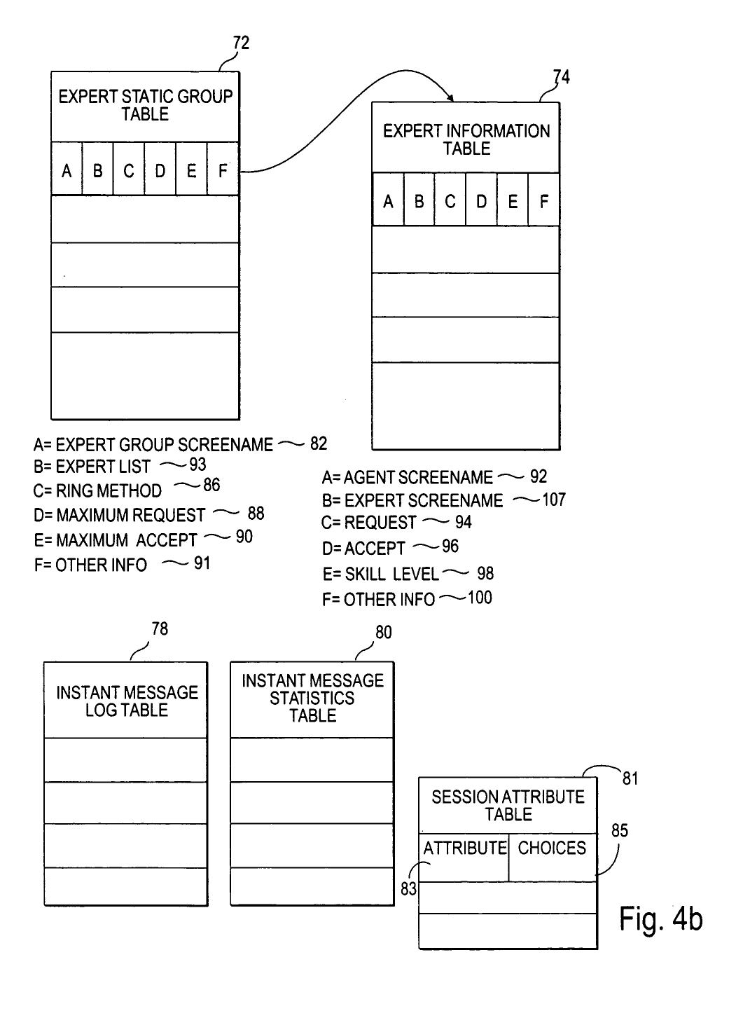

FIG. 4 is an entity relationship diagram illustrating entity relationships, according to an exemplary embodiment of the present invention. FIG. 4 includes FIGS. 4A and 4B. An entity is a resource that is utilized by the customer interaction system 4 to process calls, including instant message calls, and may take the form of a table stored in the routing database 48. As previously described, the administrative client machine 38 provides a presentation framework for configuring an entity.

Each entity has a corresponding resource object providing an interface to the entity and an optional associated property table. This architecture allows attributes to be added for each entity with minimal programming effort. The present example illustrates entity tables with corresponding attributes.

FIG. 4A is an entity relationship diagram illustrating entity relationships, according to an exemplary embodiment of the present invention, in the form of an agent static information table 65, an expert static information table 67 and an expert table 76. The expert static information table 67 is linked to the expert table 76.

The agent static information table 65 specifies static information relating to agents 42. The agent static information table 65 includes an agent screenname 92, and expert group list 69, an expert list 71 and other information 73. The agent screenname 92 is the instant message screenname of the agent that is configured from the administrative client machine 38 and registered with instant message services by the instant message adapter machine 33. In some embodiments multiple agent screennames 92 may be configured for the agent 42. The expert group list 69 identifies expert groups that are presented to the agent 42 on the agent desktop machine 40. For example, an administrator may utilize the administrative client machine 38 to configure the expert group list 60 for each agent 42. Thus each agent may select only from the expert groups presented. The expert list 71 identifies experts 51 that are presented to the agent 42 on the agent desktop machine 40. For example, an administrator may utilize the administrative client machine 38 to configure the expert list 71 for each agent 42. Thus each agent 42 may select only from the experts 51 presented.

The expert static information table 67 specifies static information relating to experts. Each entry corresponds to an expert 51 and includes an expert screenname field 107 and other information 75. The expert screenname 107 is the instant message screenname of the expert 51 as determined by the administrator. In some embodiments multiple expert screennames 107 may be configured for an expert 51. The other information 75 includes areas of expertise, product expertise, skill level, language expertise, and other information that characterize the skills, talent or knowledge of the expert.

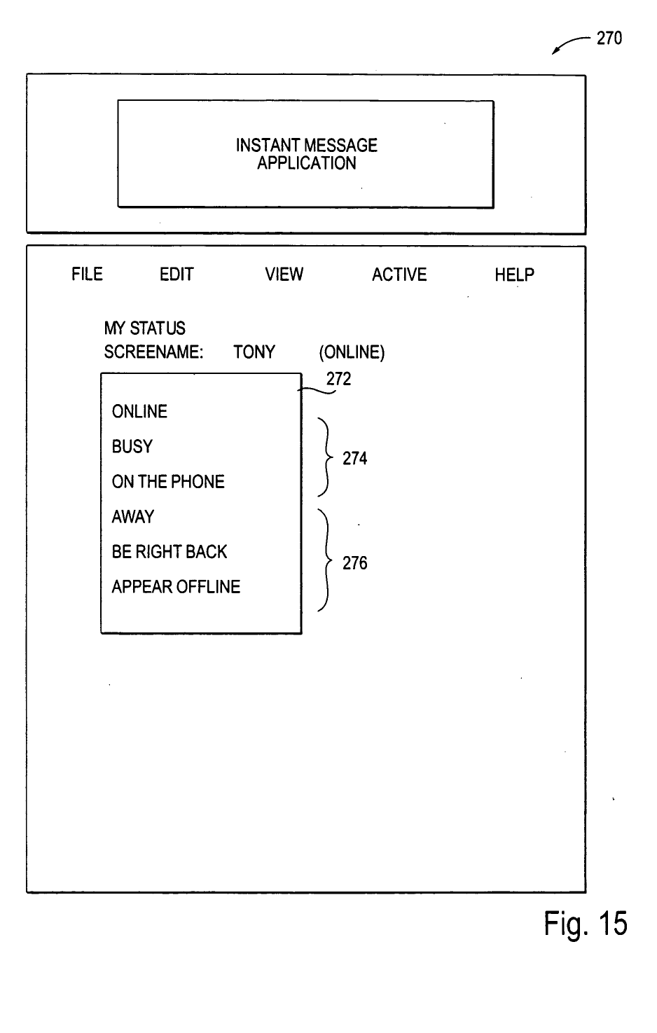

The expert table 76 specifies dynamic information relating to experts. Each entry corresponds to an expert and includes a status 106 and other information 101. The status 106 is set by the agent 41 or expert 51 (e.g., or any instant message user) and/or an instant message service. FIG. 15 illustrates a user interface 270, according to an exemplary embodiment of the present invention, to update the status 106 as set by an instant message user. The user interface 270 includes the status 106 of online 272 or interrupt statuses 274, indicating the instant message user is present and interruptible (e.g., Busy, On the phone, etc.), or non-interrupt status 276, indicating the instant message user may not be interrupted (e.g., Away, Be right back, Appear Offline, etc.) because the user is not available. The connection module 64 monitors the status 106 of all experts associated with the customer interaction system 4 on predetermined instant message services and updates the status 106 accordingly.

The other information 101 includes dynamic information relating to the expert (e.g., greatest time since last request serviced, the quickest response time, number of requests serviced in the last hour, etc.).

In an alternate embodiment the agent static information table 65, the expert static information table 67, the expert table 76 may be located in a database that is coupled to the instant message adapter machine 33.

FIG. 4B, is an entity relationship diagram illustrating entity relationships, according to an exemplary embodiment of the present invention, in the form of an expert static group table 72; an expert information table 74, an instant message log table 78, an instant message statistics table 80, and an instant message session attribute table 81.

The expert static group table 72 includes static information for expert groups. The expert static group table 72 includes an entry for each expert group recognized by the customer interaction system 4. Each expert group entry includes an expert group screenname 82, an expert list 93, a ring method field 86, a maximum request field 88, a maximum accept field 90 and an other information 91. The expert group screenname 82 is an instant message screenname that is associated with the corresponding expert group and registered with the instant message service by the instant message adapter machine 33. It will be appreciated by a person having ordinary skill in the art that other embodiments may dynamically assign more than one expert group screenname 82 to the expert group thereby enabling multiple instant message sessions for an agent 42 or an expert 51 within a single expert group.

The expert list 93 specifies the experts 51 that are associated with the expert group as configured from the administrative client machine 38 by an administrator. The ring method field 86 specifies the method for contacting the identified experts 51 to request assistance and may specify a parallel or serial ring method. For example, a parallel ring method would result in multicasting the same instant message to each of the candidate experts 51 and the serial ring method would result in sending an instant message to a single candidate expert 51 at a time and waiting for a response before ringing the next candidate expert. The maximum request field 88 specifies the maximum number of experts that may be requested for assistance. The maximum accept field 90 specifies the maximum number of experts that may accept a request for assistance.

The expert information table 74 specifies dynamic information relating to expert-agent associations within a specific expert group. Each entry specifies information relating to an expert and an agent and includes an agent screenname 92, an expert screenname 107, a request field 94, an accept field 96 and other information 100. The identification module 70 updates the agent screenname 92 in the expert information table 74 with the agent screename 92 and updates the expert screenname 107 in the expert information table 74 with the expert screename 92 in response to identifying a candidate expert 51 that may service a request for assistance from the agent 42. The request field 94 is asserted by the identification module 70 in response to the identification module 70 requesting assistance from the expert 51 to respond to the request for assistance from the agent 42. The accept field 96 is asserted by the connection module 64 in response to the connection module 64 registering acceptance by an expert 51.

The instant message log table 78 is utilized to store the content of agent-expert instant message text and associated message metadata (e.g., sender and receiver screennames, session attribute choices, topics, subjects, etc.). The contents of the log may be subsequently scrutinized by management to understand agent training needs, improve agent readiness and competence, identify non-performing agents, identify agents that ask the same questions and discourage the use of agent-expert consultations time for non-business purposes.

The instant message statistics table 80 is collected by the administrative module 66 and is utilized to store statistical information that relates to the expert support system. Statistics may be utilized to generate reports. For example, statistics captured and/or reported may include the number of agent-expert consultations (e.g., instant message requests for assistance from an agent that were accepted by at least one expert) and the time utilized for agent-expert consultation (e.g., time required to provide assistance). The total number of agent-expert consultations may be counted in addition to agent-expert consultations with respect to an application (e.g., a category which characterizes the customer query), an agent, an expert and an expert group. The number of agent-expert consultations for the agent, the application, the expert and the expert group may also be expressed as a percentage of the total number of agent-expert consultations.

The total time of agent-expert consultation may also be captured in addition to the time of agent-expert consultation with respect to an application (e.g., a category which characterizes the customer query), an agent, an expert and an expert group. The time of agent-expert consultation for the agent, the application, the expert and the expert group may also be expressed as a percentage of the total time of agent-expert consultations. In addition, the total and percentage time for an agent may be itemized with respect to an expert and expert group; the total and percentage time for an expert may be itemized with respect to an agent and an expert group; and, the total and percentage time for an expert group may be itemized with respect to an agent and an expert.

The instant message attribute table 81 stores session attributes that are configured by the administrator from the client machine 38. Each entry includes an attribute 83 (e.g., geographical region) and choices 85 (e.g., north, south, east and west). An agent may select one of the configured choices from a pull down menu prior to requesting assistance.

In an alternate embodiment the expert static group table 72, the expert information table 74, the instant message log table 78, the instant message statistics table 80 and the session attribute table 81 may be located in a database that is coupled to the instant message adapter machine 33.

### Methods

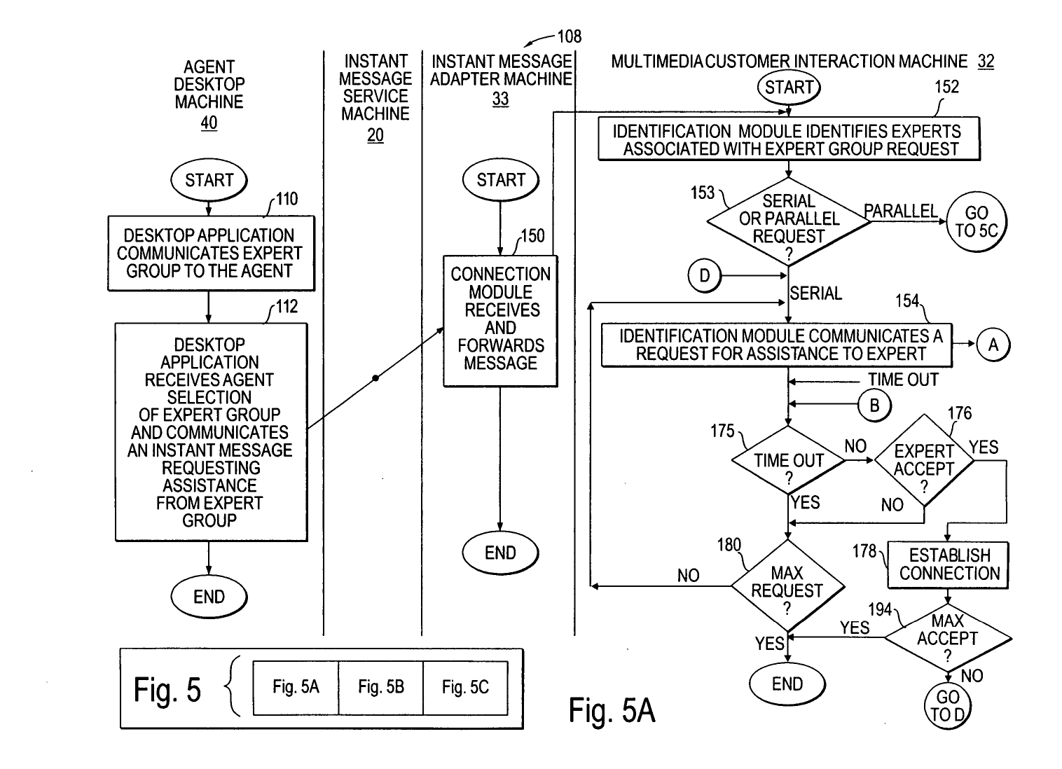

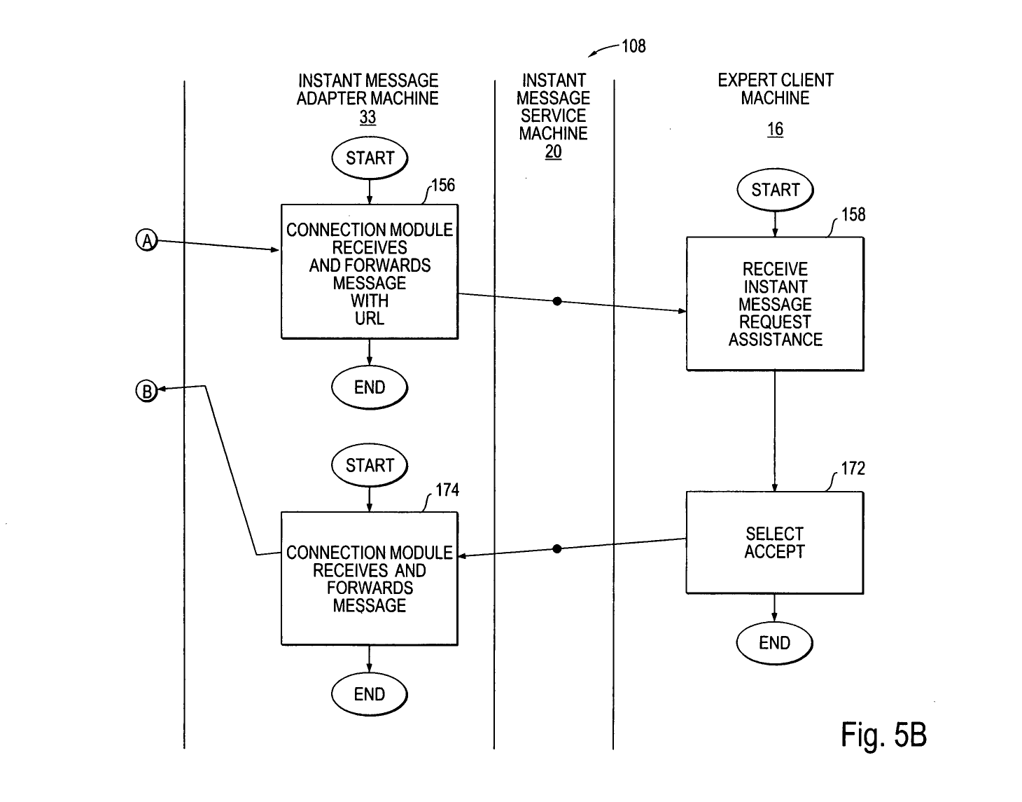

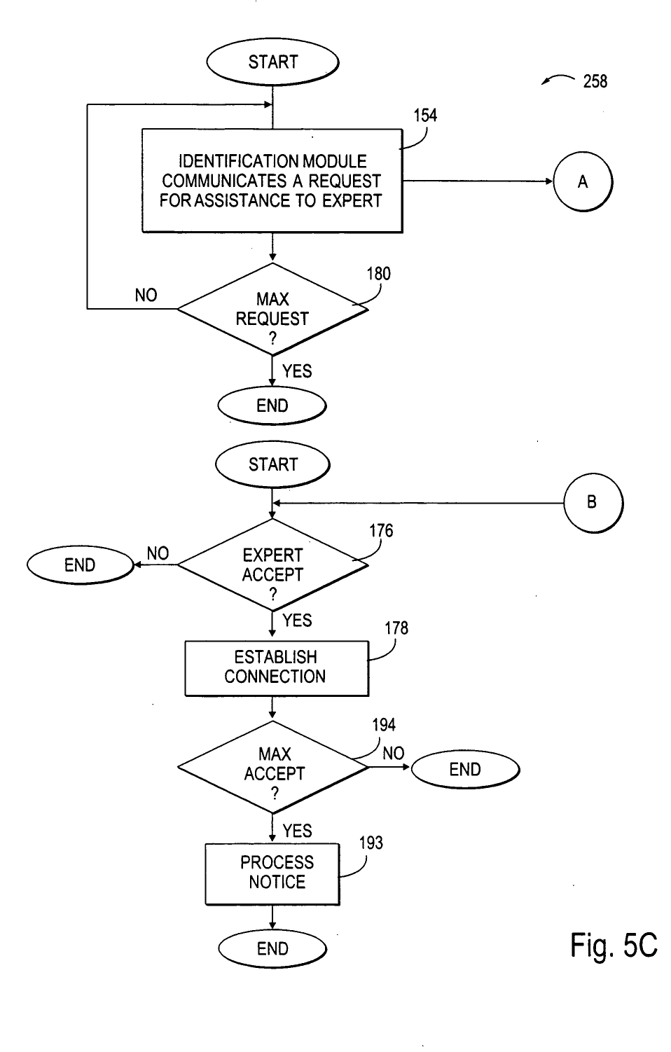

FIG. 5 is a flow chart illustrating a method 108, according to an exemplary embodiment of the present invention to respond to a customer or requester query received at a customer interaction system. FIG. 5 includes FIGS. 5A, 5B and 5C. The embodiment described below processes a customer query; however, processing a requester query is performed in the same manner.

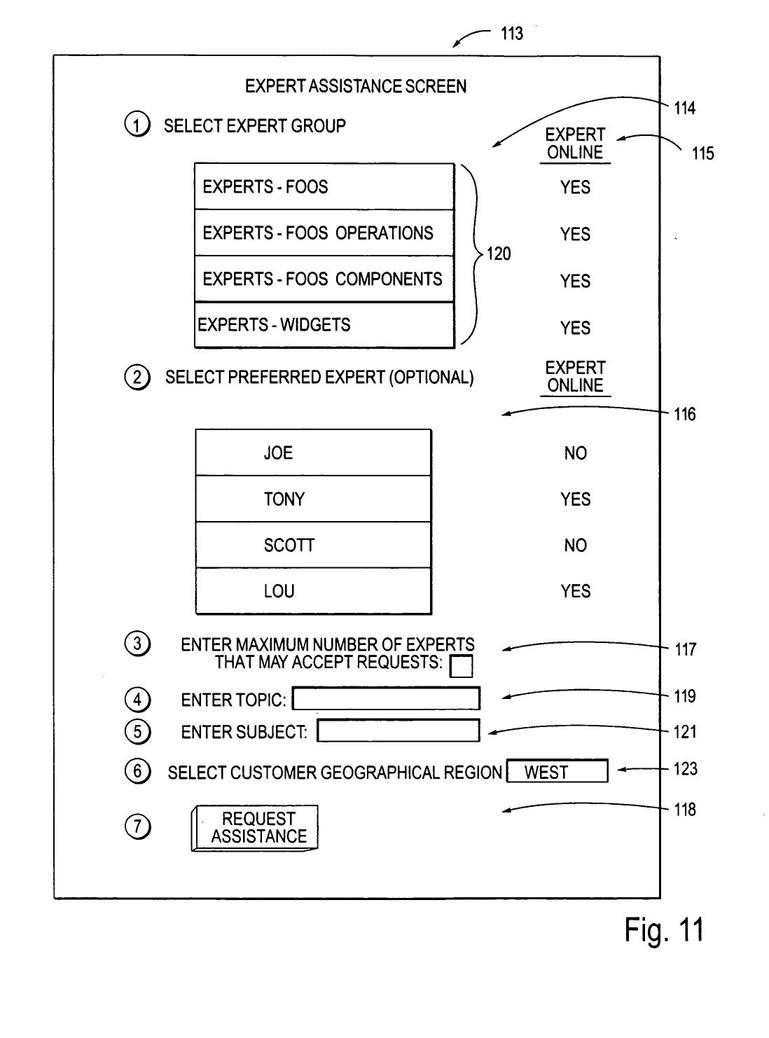

At box 110, an agent 42 seated at agent desktop machine 40 has received a call from the customer 22 via the customer interaction system 4. The customer call may take the form of a telephone call, an instant message, an email, a web request, etc. After interviewing the customer the agent 42 determines that expert assistance is required to respond to a customer query and views an expert assistance screen 113 that is communicated by the identification module 70 to the agent in response to the agent identifying himself or herself to the customer interaction system 4. FIG. 11 illustrates a user interface, according to an exemplary embodiment of the present invention, in the form of the expert assistance screen 113. The expert assistance screen 113 includes an expert group window 114, an expert online indicator 115, a preferred expert window 116, a maximum request window 117, a topic window 119, a subject window 121, a session attribute pull down menu 123 and a request assistance button 118.

The expert group window 114 includes various expert groups 120 each specializing in a product or a subject relating to a product. For example, an expert group “Expert-Foos” identifies a group of experts 51 that support “Foos” and an expert group “Experts-Foos Components” identifies an expert group that supports Foo Components. The expert groups 120 communicated to the agent are identified via the expert group list 69 in the agent static information table 65 and are determined by an administrator that configures the expert group list 69 to identify the expert groups that may be accessed by the identified agent. The identification module 70 responds to the agent registering their identity with the customer interaction system 4 by reading the agent static information table 65 and communicating the appropriate expert groups 120 to the agent.

The expert online indicator 115 includes the text “Yes” if the associated expert group includes at least one expert that is presently registered online 272. In addition, a similar indicator is provided for individual experts. Thus, the agent may be informed whether an expert is available to accept the request before making the request.

An exemplary preferred expert window 116 includes the names of experts that the agent 42 may select to identify a preferred expert. For example, the agent 42 may know the name of an expert that has the desired expertise or might uniquely appreciate the customer's query. The experts communicated to the agent are identified via the expert list 71 of the agent static information table 65 and are determined by an administrator that configures which experts the agent may access. The identification module 70 responds to the agent registering their identity with the customer interaction system 4 by reading the agent static information table 65 and communicating the appropriate experts 51 to the agent 42.

The maximum request window 117 provides a window for an agent 42 to specify the maximum number of experts 51 that may accept a request for assistance. Thus an agent 42 that enters the number three into the maximum request window 117 specifies that three experts 51 may accept the request for assistance.

The topic window 119 and the subject window 121 provide a window for an agent 42 to enter the topic and subject information prior to requesting assistance. Topic and subject information are associated with instant message text of the same session and stored in the instant message log table 78 for subsequent search and retrieval.

The session attribute pull down menu 123 enables the agent 42 to identify attributes with respect to the current session. In the present embodiment, the agent 42 may select the customers 22 geographical region from the session attribute pull down menu 123 that includes the choices 85, West, East, South and North. Other embodiments may include attributes describing customer importance (e.g., VIP, preferred, etc.). Session attributes 83 and their associated choices 85 may be configured by a system administrator from the administrative client machine 38 and stored in the session attribute table 81. Session attributes 83 are associated with instant message text of the same session and stored in the instant message log table 78 for search and retrieval.

The agent completes a request for expert assistance by selecting the request assistance button 118.

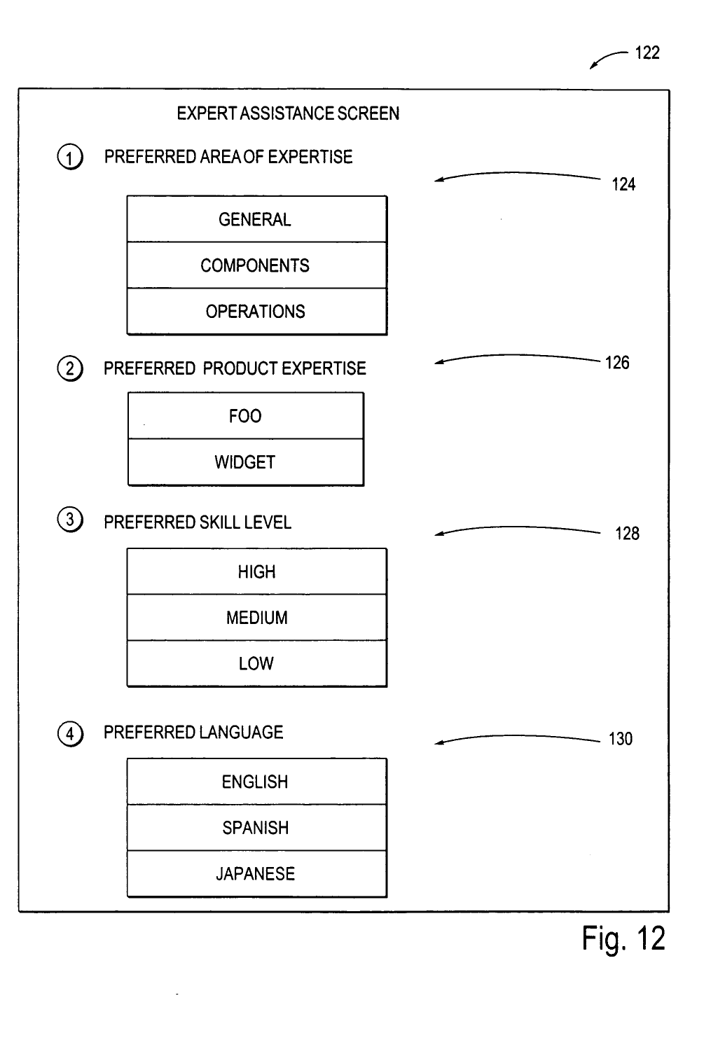

In an alternate embodiment, the agent may specify preferences that are utilized to select candidate experts. FIG. 12 illustrates a user interface, according to an exemplary embodiment of the present invention, in the form of the expert assistance screen 122. The expert assistance screen 122 includes a preferred area of expertise window 124, a preferred product expertise window 126, a preferred skill level window 128, and a preferred language expertise window 130. The preferred area of expertise 114 window enables the agent to select an expert with a preferred area of expertise. Illustrated examples include components, operations, etc.. Another example may include business functions (e.g., accounting, marketing, sales, support, services, etc.). In both examples the agent selects an expert with preferred area of expertise.

The preferred product expertise window 126 enables the agent 42 to select an expert 51 with a preferred product expertise. Illustrated examples include Foos and Widgets. Other examples may include different models of products (e.g., Foo-A, Foo-B), or products with different feature sets or options (Widget for business environment, Widget for home environment, Widget with eight-cylinder engine).

The preferred skill level window 128 enables the agent 42 to select an expert 51 with a preferred skill level. Illustrated examples include High, Medium and Low. Implicit in the Agent's 42 preferred skill level may be the notion of expert availability. Thus, the Agent most probably will quickly find an expert with a “Low” skill level but may wait for an expert with a “High” skill level.

The preferred language level window 130 enables the agent 42 to select an expert 51 with one or more language skills. Illustrated examples include English, Spanish and Japanese. The selection of the agent 42 may implicitly include the notion of expert availability. Thus, the agent 42 most probably will quickly find an expert 51 that speaks “English” but may have to wait for an expert 51 that speaks “Spanish” and “Japanese”.

Returning to FIG. 5A, at box 112 the desktop application 58 receives the selections form the agent 42 and communicates an instant message requesting assistance from the selected expert group and the optional preferred expert 51.

At box 150, the web interaction server machine 30 receives the instant message from the instant message service machine 20. The web interaction server machine 30, forwards the instant message to the connection module 64 at the instant message adapter machine 33. The connection module 64 communicates the information in the instant message to the identification module 70 at the multimedia customer interaction machine 9 for routing to an expert 51 or group of experts.

At box 152, the identification module 70 receives the request for assistance and invokes the appropriate workflow 68 to identify one or more candidate experts 51. The identification module 70 identifies the appropriate workflow based on the selection of the agent 42 (e.g., expert group, expert group with preferred expert, expert preferences, etc.).

In response to the agent 42 selecting the expert group, the appropriate workflow 68 identifies the maximum number of candidate experts 51 by reading the maximum request field 88 in the associated expert static group table 72. For example, the maximum request field 88 indicating three would limit the number of candidate experts 51 to the same amount even though the expert group indicated by the agent 42 (e.g., Experts—Foos Operations) may include six experts 51. Further, the workflow may read the dynamic information from the routing database 48 to identify candidate experts 51 with a status of online 272 (e.g., status 106) and those candidate experts 51 that have waited longest for a request (e.g., other information 100) or to maintain a round robin algorithm for allocating requests (e.g., other information 100). The workflow 68 identifies an expert 51 as a candidate expert by writing the agent screenname 92 and the expert screenname 107 into an entry of the expert information table 74.

In response to the agent 42 selecting a preferred expert 51, another workflow 68 may be invoked to possibly add the preferred expert 51 to the candidate experts 51 already provided. The workflow ensures that the selected expert 51 is a member of the expert group and the preferred expert 51 has a status 106 that is registered as online 272. The workflow 68 identifies the additional expert 51 as a candidate expert by writing the agent screenname 92 and the expert screenname 107 into an entry of the expert information table 74.

In response to the agent 42 selecting a preferred area of expertise 124 and/or a preferred product expertise 126 and/or a preferred skill level 128 and/or a preferred language expertise 130 the appropriate workflow would search the other information 75 in the expert static information table 67 to identify candidate experts 51 that match the preferences of the agent 42. Further, the workflow may read dynamic information to further sort or filter a candidate expert 51 by identifying experts 51 that are presently online 272 and/or by identifying experts 51 have waited longest for a request and/or by identifying experts 51 that have been least utilized over an extended period of time. As previously stated, the number of candidate experts 51 that are identified may be limited by the maximum request field 88. The workflow 68 identifies a preferred expert 51 as a candidate expert 51 by writing the agent screenname 92 and the expert screenname 107 into an entry of the expert information table 74.

At decision box 153, the identification module 70 determines if the serial or parallel ring method is configured, by reading the ring method field 86 in the expert static group table 72. If a serial ring method is configured, then processing continues processing continues at box 154. Otherwise processing continues on FIG. 5C at box 154.

At box 154, the identification module 70 communicates a request for assistance to the expert 51 via the connection module 64 on the instant message adapter machine 33 and sets the corresponding request field 94 in the expert information table 74.

At box 156, in FIG. 5B, the connection module 64 on the instant message adapter machine 33 receives the request for assistance and formats it into an instant message including a URL that is forwarded to the expert client machine 16 via the web interaction server machine 30 and the instant message service machine 20.

At box 158, the client application program 50 on the expert client machine 16 receives the instant message including the request for assistance, which is displayed to the expert 51 seated at the expert client machine 16.

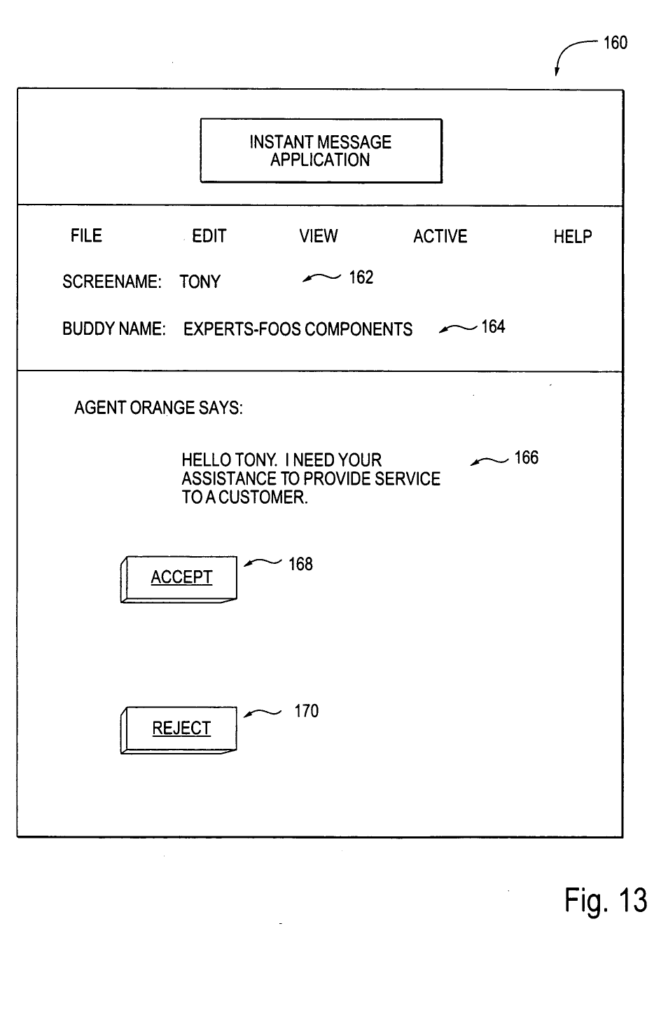

FIG. 13 illustrates a user interface 160 that includes a request for assistance from an expert, according to an exemplary embodiment of the present invention. The instant message 160 includes an expert screenname 162, an expert group buddyname 164, a request for assistance 166, an accept button 168, and a reject button 170. The expert screenname 162 identifies the expert as “TONY”. The expert group buddyname 164 identifies the expert group “EXPERTS-FOOS COMPONENTS”. The message 166 indicates that “AGENT ORANGE” is requesting assistance from “TONY” to provide service to a customer. The expert 51 may respond to the request for assistance by selecting the accept button 168, the reject button 170 or by ignoring the request.

Returning to FIG. 5B, at box 172, the expert 51 selects the accept button 168. In one embodiment, selection of the accept button 168 may result in the client application program 50 communicating an instant message via the instant message service to the web interaction server machine 30 which is forwarded to the instant message adapter machine 33. In an alternate embodiment, selection of the accept button 168 may result in the client application program communicating a URL to the web interaction server machine 30 that, in turn, is communicated to the instant message adapter machine 33.

At box 174, the connection module 64 on the instant message adapter machine 33 receives the message (e.g., instant message, URL, etc.) and forwards the message to the identification module 70 on the multimedia customer interaction machine 32.

Returning to FIG. 5A, at decision box 175, the identification module 70 branches to decision box 180 if a timeout has occurred (e.g., the expert 51 has not responded within a predetermined amount of time). Otherwise the identification module 70 branches to decision box 176.

At decision box 176, the identification module 70 determines if the expert 51 has selected the accept button 168. If the expert 51 has selected the accept button 168, then processing continues at box 178. Otherwise, processing continues at decision box 180.

At decision box 180, the identification module 70 determines if the maximum number of experts 51 have been requested. The identification module 70 makes the determination by summing experts 51 (e.g., the appropriate expert screenname 107 and agent screenname 92 pairs) in the expert information table 74 that have received a request for assistance (e.g., request field 94 is asserted) and comparing it to the maximum request field 88 in the expert static group table 72. If the maximum numbers of experts have been requested, then processing ends. Otherwise processing continues at box 154.

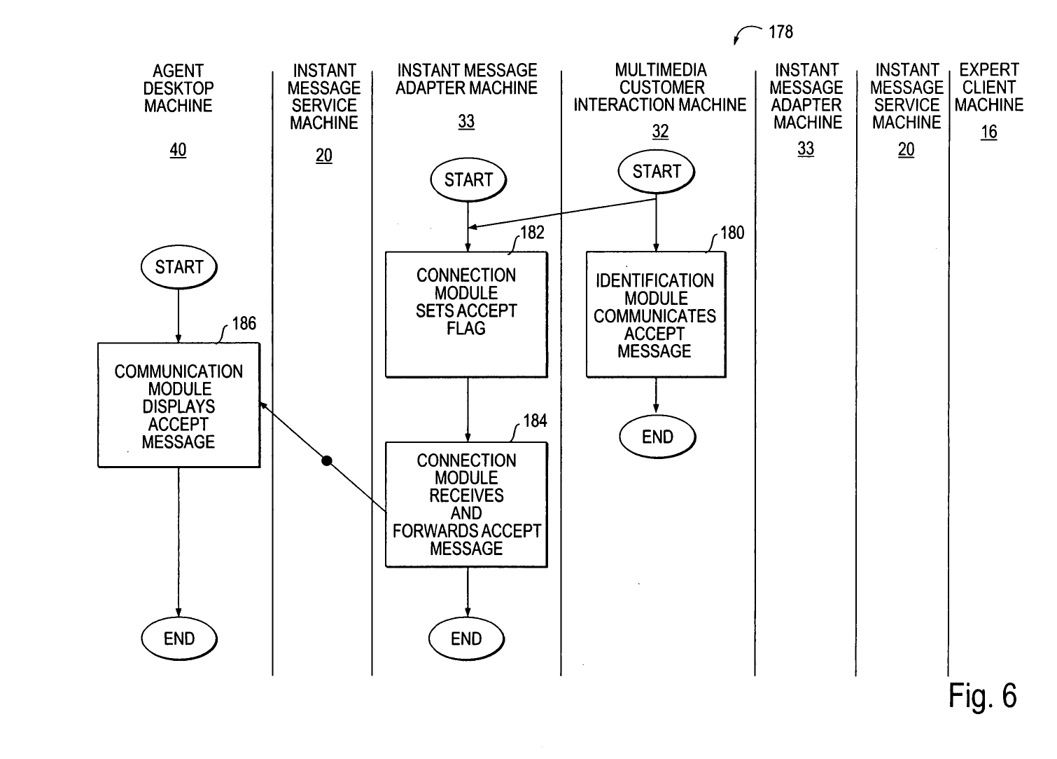

At box 178, a connection is established between the expert client machine 16 and the agent desktop machine 40. Box 178 corresponds to FIG. 6, which illustrates a method 178.

At decision box 194, the identification module 70 determines if the maximum number of experts 51 have accepted the request for assistance. The identification module 70 makes this determination by summing experts 51 in the expert information table 74 that have accepted the request for assistance (e.g., accept field 94 is asserted) and comparing it to the maximum accept field 90 in the expert static group table 72. If the maximum number of experts have not accepted, then processing continues at box 154 (e.g., goto D). Otherwise processing ends.

In another embodiment the maximum number of experts that have accepted are compared with a value entered by the agent 42 in the maximum request window 117. In yet another embodiment the maximum number of experts 51 is determined by comparing the amount of time that has elapsed after communicating a request for assistance to the expert 51 with a maximum accept time configured that is configured in a workflow. For example, if the most recent connection was established after the maximum accept time then the most recent connection is disconnected and further connections are disallowed.

FIG. 6 illustrates a method 178, according to an exemplary embodiment of the present invention, to establish a connection.

At box 180, the identification module 70 communicates an accept message to the connection module 64 on the instant message adapter machine 33.

At box 182, the connection module 64 on the instant message adapter machine 33 receives the accept message and sets the accept field 96 in the expert information table 174.

At box 184, the connection module 64 forwards the accept message via the web interaction server machine 30 via the instant message service machine 20 to the agent desktop machine 40.

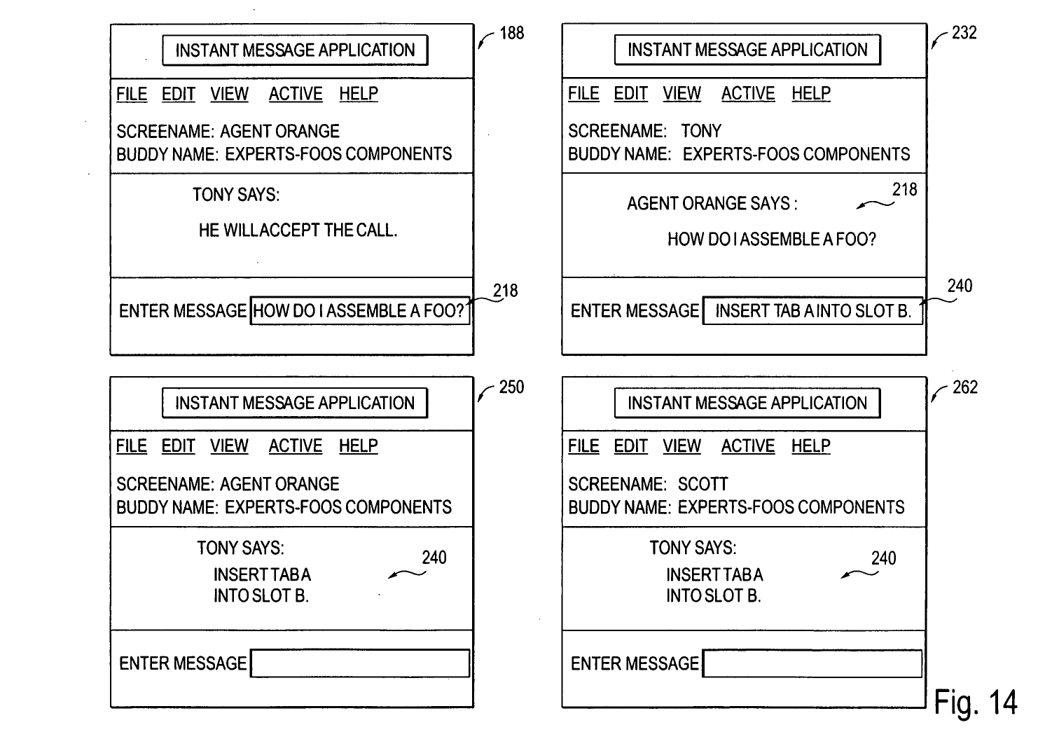

At box 186, the desktop application 58 receives and displays the accept message to the agent 42 as shown in FIG. 14 which illustrates a user interface screen 188, according to an exemplary embodiment of the present invention. The user interface screen 188 identifies the agent as “AGENT ORANGE” and “TONY” as a member of the expert group “EXPERTS-FOO COMPONENTS”. The body of the instant message indicates that Tony “will accept the call”.

FIG. 5C illustrates a method 258, according to an exemplary embodiment of the present invention, to process a parallel request.

At box 154, the identification module 70 communicates a request for assistance as previously described.

At decision box 180, the identification module 70 determines if the maximum number of experts 51 have been requested as previously described. If the maximum numbers of experts 51 have been requested, then processing ends. Otherwise processing continues at box 154.

At decision box 176, the identification module 70 determines if the expert 51 has accepted the request for assistance as previously described. If the expert 51 has accepted the request for assistance then processing continues at box 178. Otherwise processing ends.

At box 178, a connection is established as previously described.

At decision box 194, the identification module 70 determines the maximum number of experts 51 that have accepted the request for assistance and processes the determination, as previously described. If the maximum number of experts 51 have not accepted then processing ends. Otherwise processing continues at box 193.

At box 193, a method 193 is invoked to process notice.

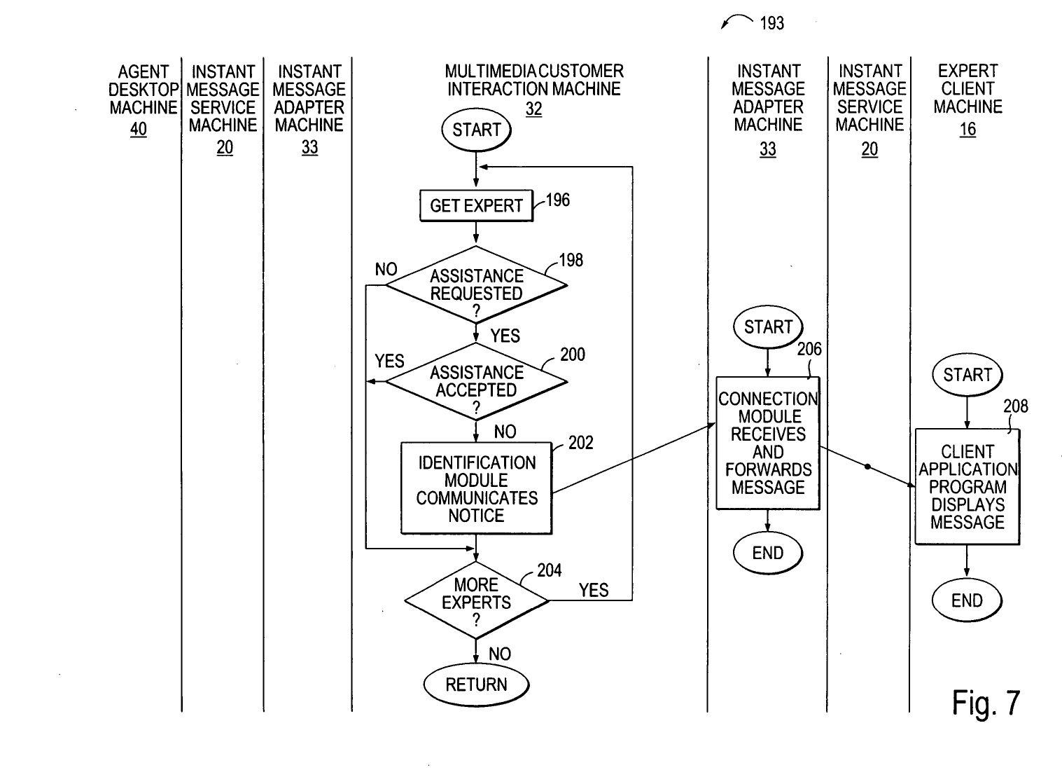

FIG. 7 illustrates a method 193, according to an exemplary embodiment of the present invention, to process notice. At box 196, the identification module 70 gets a candidate expert 51 from the candidate experts 51, previously identified by the workflow, to respond to the request for assistance from the agent 42.

At decision box 198, the identification module 70 determines if a request for assistance was communicated to the expert client machine 16. If a request for assistance was communicated (e.g., request field 94 asserted), then processing continues at decision box 200. Otherwise processing continues at decision box 204.

At decision box 200, the identification module 70 determines if the expert 51 accepted the request for assistance by reading the accept field 96 in the expert information table 74. If assistance was accepted, then processing continues at decision box 204. Otherwise processing continues at box 202.

At box 202, the identification module 70 communicates a message to the connection module 64 at the instant message adapter machine 33 including a notice that assistance has already been provided by another expert 51; therefore, the request for assistance may no longer be accepted.

At box 206, the connection module 64 on the instant message adapter machine 33 receives and forwards the notice via the web interaction server machine 30 via the instant message service machine 20 to the expert client machine 16.

At box 208, the client application program 50 on the expert client machine 16 displays the notice to the expert 51.

At decision box 204, the identification module on the multimedia customer interaction machine 32 determines if there are more experts 51 in the expert group. If there are more experts 51 in the expert group, then processing continues at box 196. Otherwise processing ends.

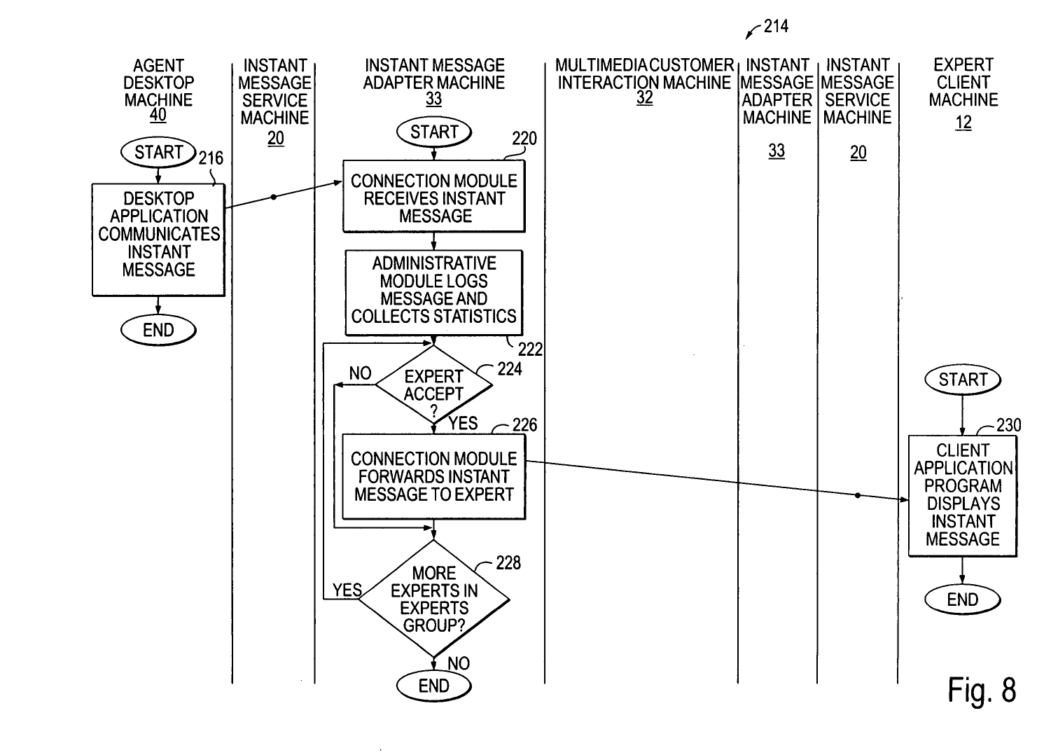

FIG. 8 illustrates a method 214, according to an exemplary embodiment of the present invention, to log an instant message and capture statistics for an instant message communicated by an agent desktop machine 40 to an expert group.

At box 216, the agent 42 communicates an instant message to the “EXPERTS-FOOS COMPONENTS” expert group. FIG. 14 illustrates a user interface screen 188, according to an exemplary embodiment of the present invention, illustrating an example instant message that may be communicated by an agent desktop machine 40 to the expert group that includes a message 218, “How do I assemble a foo?” Returning to FIG. 8, at box 216, the desktop application 58 communicates the instant message 218 to the instant message service machine 20, that in turn, communicates the instant message 218 to the web interaction server machine 30 that, in turn, communicates the instant message 218 to the connection module 64 at the instant message adapter machine 33.

At box 220, the connection module 64 on the instant message adapter machine 33 receives the instant message 218.

At box 222, the connection module 64 invokes the administrative module 66, which logs the instant message 218, associated instant message metadata (e.g. screennames, topic, subject, session attributes, etc.) and appropriate statistics. The administrative module 66 stores statistics in the instant message statistics table 80 on the routing database 48. The administrative module 66 further stores instant messages 218 and associated instant message metadata in the instant message log table 78 for each instant message session in the routing database 48. Searching instant message metadata (e.g., topic information, subject information and session attributes) enables retrieval of corresponding instant message transcripts thereby enhancing expert support services.

At decision box 224, the connection module 64 determines if the expert 51 in the “EXPERTS-FOOS COMPONENTS” expert group has accepted the request for assistance from the “AGENT ORANGE” by examining accept field 96 and the agent sreenname 92 in the expert information table 74. If the expert 51 has accepted a request for assistance from Agent Orange, then processing continues at decision box 226. Otherwise processing continues at decision box 228.

At box 226, the connection module 64 utilizes the agent screenname 92 and the expert group screenname 82 (e.g., buddyname) in the instant message 218 to forward the instant message 240 to the experts associated with the expert group screenname 82. The connection module 64 utilizes the expert group screenname 82 in the instant message 218 to identify the expert information table 74. If the agent screenname 92 in the instant message 240 matches the agent screename 92 in the present entry of the expert information table 74 then the connection module 64 extracts the corresponding expert screenname 107 and utilizes the expert screename 107 as a forwarding address for the instant message 218. The connection module 64 communicates the instant message 218 to the web interaction server machine 30 that, in turn, communicates the instant message 218 to the instant message service machine 20 that, in turn, communicates the instant message 218 to the expert client machine 16.

At decision box 228, the connection module 64 determines if there are more experts 51 in the “EXPERTS-FOOS COMPONENTS” expert group. If the connection module 64 determines that the expert group includes more experts 51, then processing continues at decision box 224. Otherwise processing ends.

At box 230, the client application program 50 at the expert client machine 16 receives and displays the instant message to the expert 51. FIG. 14 illustrates a user interface screen 232, according to an exemplary embodiment of the present invention, illustrating the instant message 218 that is received by the expert, TONY, and includes the message, “How do I assemble a foo?”

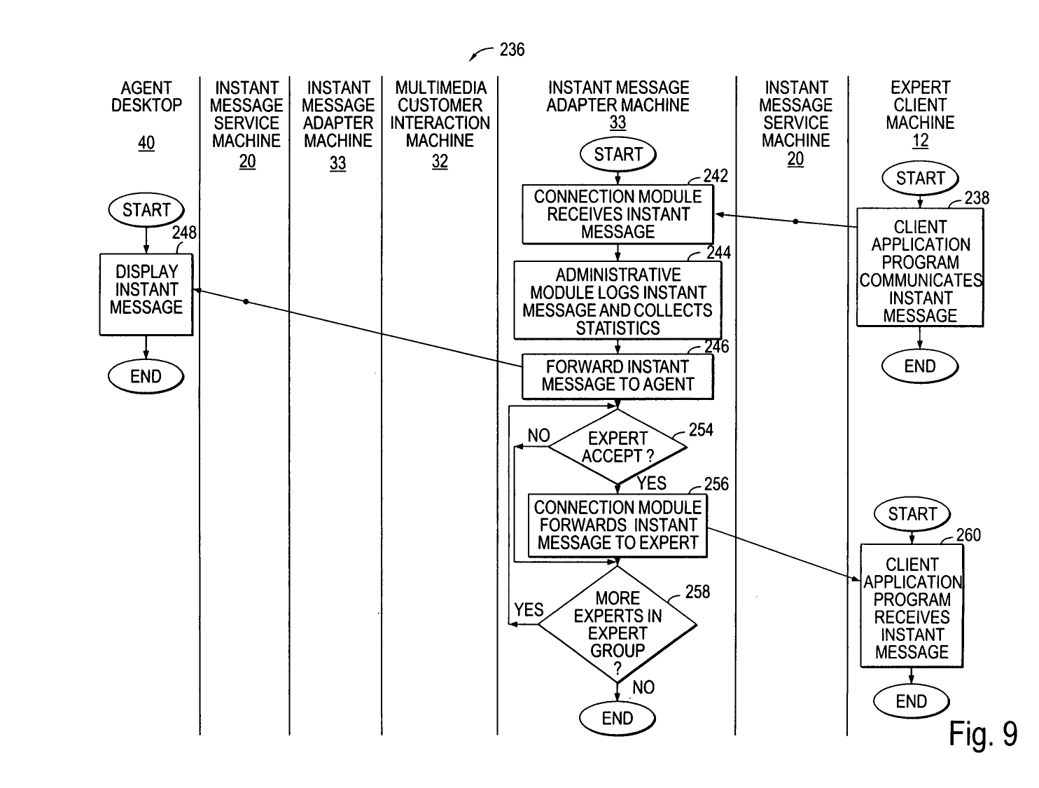

FIG. 9 illustrate a method 236, according to an exemplary embodiment of the present invention, to log an instant message and collect statistics for an instant message communicated from an expert to an expert group and agent 42.

At box 238, the expert 51 at the expert client machine 16 communicates an instant message to the “EXPERTS-FOOS COMPONENTS” expert group. FIG. 14 illustrates a user interface screen 232, according to an exemplary embodiment of the present invention, illustrating an example instant message 240 that may be communicated by an expert 51 to an expert group and agent 42 that includes the message “Insert tab A into slot B” from TONY. Returning to FIG. 9 at box 238, the client application program 50 at the expert client machine 16 communicates the instant message 240 to the instant message service machine 20 that, in turn, communicates the instant message 240 to the web interaction server machine 30 that, in turn, communicates the instant message 240 to the instant message adapter machine 33.

At box 242, the connection module 64 at the instant message adapter machine 33 receives the instant message 240.

At box 244, the connection module 64 at the instant message adapter machine 33 invokes the administrative module 66 to log the instant message 240 and collect statistics as previously described.

At box 246, the connection module 64 forwards the instant message 240 to the agent desktop machine 40. The connection module 64 utilizes the expert group screenname 82 (e.g., buddyname) in the instant message 240 to identify the appropriate expert information table 74 and the expert screenname 107 in the instant message 240 to extract the corresponding agent screenname 92 from the expert information table 74 and utilize the agent screename 92 as a forwarding address for the instant message 240. The connection module 64 communicates the instant message 240 to the web interaction server machine 30 that, in turn, communicates the instant message to the instant message service machine 20 that, in turn, communicates the instant message to the agent desktop machine 40.

At box 248, the desktop application 58 at the agent desktop machine 40 receives and displays the instant message 240 to the agent 42. FIG. 14 illustrates a user interface screen 250, according to an exemplary embodiment of the present invention, illustrating an example instant message 240 that may be received by an agent. For example the user interface screen 250 includes a text message 240 where TONY replies to the agent's previous question by responding, “Insert Tab A into slot B?”

Returning to FIG. 9, at decision box 254, the connection module 64 determines if the expert 51 in the “EXPERTS-FOOS COMPONENTS” expert group has accepted the request for assistance from the “AGENT ORANGE”. If the accept field 96, associated with the expert 51, in the expert information table 74, is asserted, then processing continues at decision box 256. Otherwise processing continues at decision box 258.

At box 256, the connection module 64 utilizes the expert screenname 107 and the expert group screenname 82 (e.g., buddyname) in the instant message 240 to forward the instant message 240 to the experts associated with the expert group screenname 82. The connection module 64 utilizes the expert group screenname 82 in the instant message 240 to identify the expert information table 74. The connection module 64 utilizes the expert screenname 107 in the instant message 240 to match the expert screename 107 in the expert information table 74 and extract the corresponding agent screenname 107. If the agent screenname 92, that was extracted, matches the agent screenname 107 in the present entry of the expert information table 74 then the connection module 64 communicates the instant message 240 to the corresponding expert screenname 82 (e.g., in the present entry) via the web interaction server machine 30 that, in turn, communicates the instant message 240 to the instant message service machine 20 that, in turn, communicates the instant message 240 to the expert client machine 16.

At decision box 258, the connection module 64 determines if there are more experts in the “EXPERTS-FOOS COMPONENTS” expert group. If the connection module 64 determines that the expert group includes more experts, then processing continues at decision box 254. Otherwise processing ends.

At box 260, the client application program 50 at the expert client machine 16 receives and displays the instant message 240 to the expert 51. FIG. 14 illustrates the user interface 262, according to an exemplary embodiment of the present invention, illustrating an example instant message that may be received by the expert 51. For example the user interface screen 232 includes a text message 240 where TONY says, “Insert Tab A into Slot B”.

An alternate embodiment of the present invention would include direct communication between the agent 42 and the expert 51 that does not include the instant message adapter machine 33 acting as a proxy. The agent 42 may communicate an instant message directly to the expert 51 by addressing (e.g., entering) an instant message with the screenname of the expert 51 rather than the screenname of the expert group. Similarly, an expert 51 may communicate an instant message directly to the agent 42 by addressing (e.g., entering) the instant message with the screenname of the agent 42 rather than the screenname of the expert group.

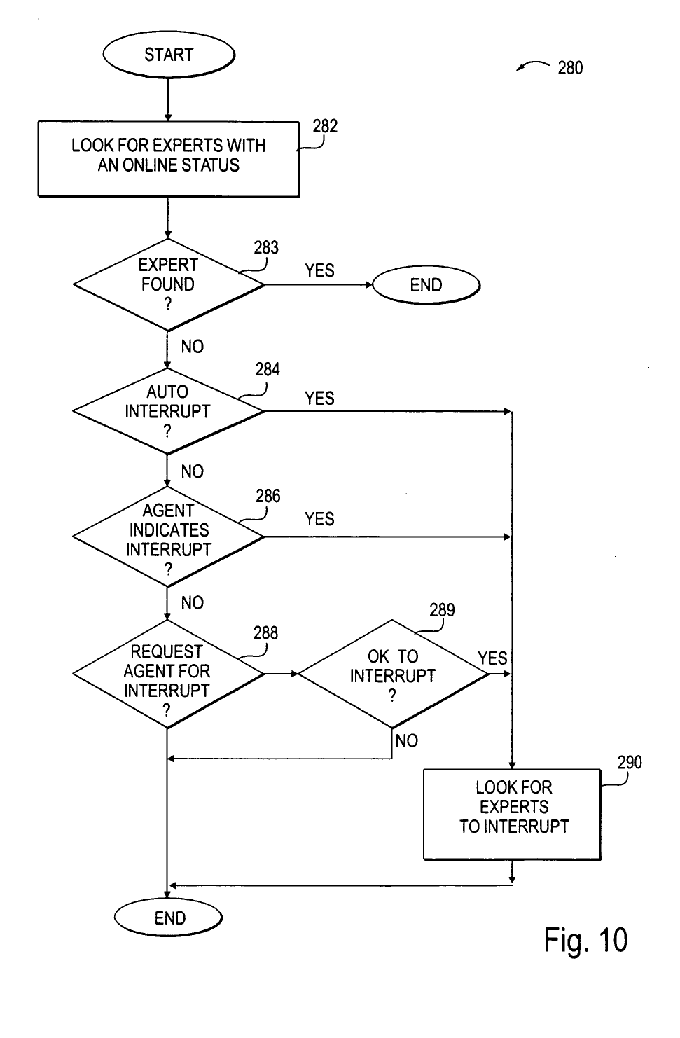

FIG. 10 illustrates a method a method 280, according to an exemplary embodiment of the present invention, to interrupt an expert 51. As previously described, a candidate expert must have an online status 272, as registered in the status 106 of the Expert Table 76, before a request for assistance will be communicated to the expert 51. In the present embodiment a request for assistance will be communicated to the expert 51 with a status that indicates he or she is not immediately available but nevertheless may be interrupted (e.g., an expert with an interrupt status 274, e.g., Busy, On the phone, etc.). As illustrated below, the identification module 70 first initiates a search for an expert 51 with a status of online 272 and, if unsuccessful, then searches for an expert 51 with interrupt statuses 274.

At box 282, the identification module 70 invokes the appropriate workflow as previously described (see method 108, FIG. 5) thereby triggering a search for candidate experts 51 with an online status 272. Processing continues at decision box 283.

At decision box 283, the identification module 70 determines if candidate experts 51 were found. If candidate experts 51 were not found then processing continues at decision box 284. Otherwise processing ends.

At decision box 284, the identification module 70 determines if experts 51 may be automatically interrupted with a request for assistance from an agent 42. If experts 51 may be automatically interrupted, then processing continues at box 290. Otherwise processing continues at decision box 286.

At decision box 286, the identification module 70 determines if the agent 42 has already indicated that experts 51 may be interrupted to service a request for assistance from an agent 42. For example, an agent 42 that requests expert assistance may also select a box on a user interface screen (e.g., expert assistance screen 113, FIG. 11; expert assistance screen 122, FIG. 12, etc.) that requests interruption of an expert 51 if one cannot be found with an online status 272. If the agent 42 has already indicated that experts 51 may be interrupted then processing continues at box 290. Otherwise processing continues at decision box 288.

At decision box 288, the identification module 70 determines if a request to interrupt an expert 51 may be communicated to the agent 42. If the request may be communicated to the agent 42 then a request is communicated to the agent 42 and processing continues at decision box 289. Otherwise processing ends.

At decision box 289, the identification module 70 determines the response received from the agent 42. If the agent 42 indicates that an expert 51 may be interrupted then processing continues at box 290. Otherwise processing ends.

At box 290, the identification module 70 invokes the appropriate workflow as previously described (see method 108, FIG. 5); however, the present invocation of the workflow triggers a search for candidate experts 51 with interrupt statuses 273 (e.g., Busy, On the Phone, etc.).

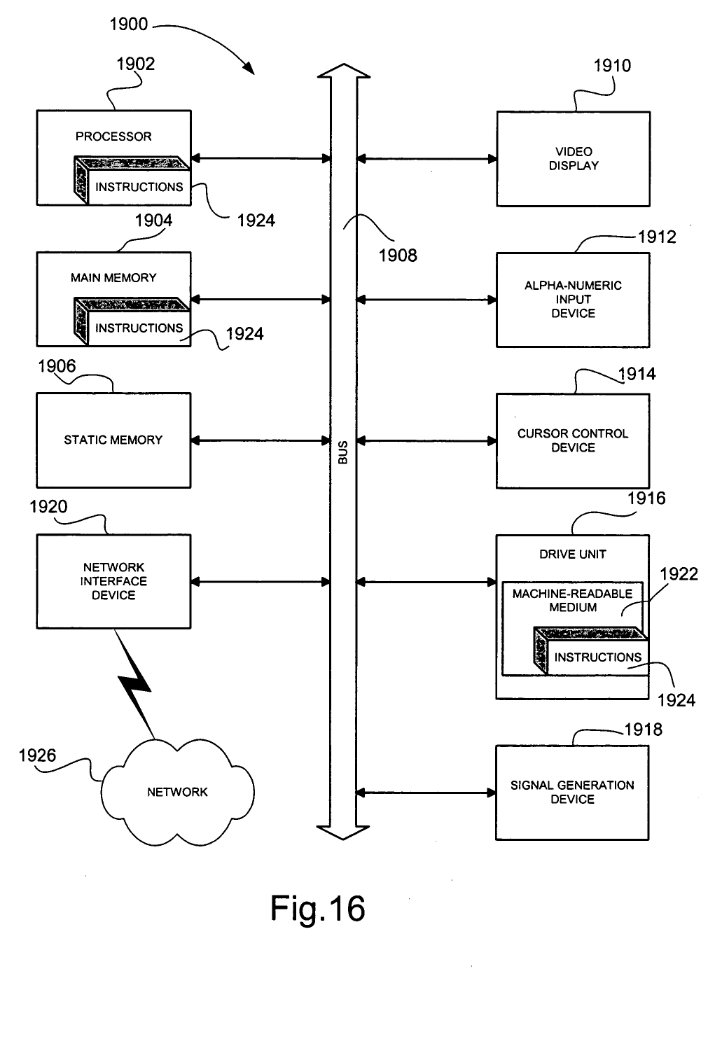

FIG. 16 shows a diagrammatic representation of machine in the exemplary form of a computer system 1900 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a service or a client machine in service-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1900 includes a processor 1902 (e.g., a central processing unit (CPU) a graphics processing unit (GPU) or both), a main memory 1904 and a static memory 1906, which communicate with each other via a bus 1908. The computer system 1900 may further include a video display unit 1910 (e.g., a liquid crystal display (LCD) or a cathode ray tube (CRT)). The computer system 1900 also includes an alpha-numeric input device 1912 (e.g., a keyboard), a cursor control device 1914 (e.g., a mouse), a disk drive unit 1916, a signal generation device 1918 (e.g., a speaker) and a network interface device 1920.

The disk drive unit 1916 includes a machine-readable medium 1922 on which is stored one or more sets of instructions (e.g., software 1924) embodying any one or more of the methodologies or functions described herein. The software 1924 may also reside, completely or at least partially, within the main memory 1904 and/or within the processor 1902 during execution thereof by the computer system 1900, the main memory 1904 and the processor 1902 also constituting machine-readable media.

The software 1924 may further be transmitted or received over a network 1926 via the network interface device 1920.

While the machine-readable medium 1992 is shown in an exemplary embodiment to be a single medium, the term “machine-readable medium” should be taken to include a single medium or multiple media (e.g., a centralized or distributed database, and/or associated caches and services) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and system to provide expert support with a customer interaction system and a method and system to respond to a requester query received at a customer interaction system has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to respond to a customer query received at a customer interaction system, the method including:
communicating at least one expert group to an agent;
receiving a selection from the agent that identifies an expert group from the at least one expert group, the selection triggering a first immediate message that includes a request for assistance from the expert group;
identifying at least one expert that is associated with the expert group; and
establishing an immediate message connection between the at least one expert and the agent, wherein the immediate message connection enables the exchange of immediate messages between the at least one expert and the agent so the agent may respond to the customer query.

2. The method of claim 1, wherein the identifying the at least one expert includes retrieving a predefined association between the at least one expert and the expert group.

3. The method of claim 1, wherein the identifying the at least one expert includes using an immediate message service to monitor a status of the at least one expert.

4. The method of claim 3, wherein the identifying the at least one expert includes identifying the at least one expert if the status of the at least one expert permits an interruption.

5. The method of claim 3, wherein the identifying the at least one expert includes executing a workflow including business logic to access configuration data associated with the at least one expert.

6. The method of claim 1, wherein the identifying of the at least one expert includes communicating via an immediate message service to determine if the at least one expert will provide expert support to the agent.

7. The method of claim 6, wherein the communicating via an immediate message service includes at least one of a parallel communication and a serial communication.

8. The method of claim 1, wherein the identifying of the at least one expert includes at least one of presenting the request for assistance to all experts in the expert group and presenting the request for assistance to a predetermined number of experts in the expert group and presenting the request for assistance to at least one expert based on preferences selected by an agent.

9. The method of claim 8, wherein the identifying of the at least one expert includes accepting the request for assistance from a single expert.

10. The method of claim 9, further including notifying and excluding other experts from accepting the request for assistance.

11. The method of claim 8, wherein the identifying of the at least one expert includes identifying a predetermined number of experts that accepts the request for assistance.

12. The method of claim 1, wherein the establishing of the immediate message connection includes connecting the agent to a customer interaction system, which in turn, is connected to the at least one expert.

13. The method of claim 12, wherein the customer interaction system is dropped from the immediate message connection.

14. The method of claim 1, wherein the expert group, the at least one expert and the agent are identified with instant message screennames.

15. The method of claim 1, wherein the immediate message includes an instant message and the immediate message connection includes an instant message connection and an immediate message service includes an instant message service and an immediate message session includes an instant message session and an immediate message metadata includes an instant message metadata.

16. The method of claim 1, wherein the customer query includes at least one of an email, a telephone call, a second immediate message, and a web chat that is established and processed by a customer interaction system.

17. The method of claim 15, further including logging an immediate message session between the agent and the at least one expert in an immediate message log for subsequent searching, wherein the immediate message session includes immediate message metadata and immediate messages.

18. The method of claim 16, further including capturing statistics on a plurality of immediate message sessions and reporting the statistics to facilitate the management of the customer interaction system.

19. The method of claim 1, wherein the identifying the at least one expert includes identifying the at least one expert based on the name of an expert that was selected by the agent.

20. The method of claim 1, wherein communicating at least one expert group to the agent includes communicating expert groups associated with the agent.

21. A system to respond to a customer query received at a customer interaction system, the system including:
a communication module to communicate at least one expert group to an agent, the communication module to further receive a selection from the agent that identifies an expert group from the at least one expert group, the selection triggering a first immediate message that includes a request for assistance from the at least one expert group;
an identification module to identify at least one expert that is associated with the expert group; and
a connection module to establish an immediate message connection between the at least one expert and the agent, wherein the immediate message connection enables the exchange of immediate messages between the at least one expert and the agent so the agent may respond to the customer query.

22. The system of claim 21, wherein the identification module is to retrieve a predefined association between the at least one expert and the expert group to identify the at least one expert.

23. The system of claim 21, wherein the identification module is to utilize an immediate message service to monitor a status of the at least one expert.

24. The system of claim 23, wherein the identification module is to identify the at least one expert if the status of the at least one expert permits an interruption.

25. The system of claim 23, wherein the identification module is to execute a workflow that includes business logic to access configuration data associated with the at least one expert to identify the at least one expert

26. The system of claim 21, wherein the identification module is to communicate via an immediate message service to determine if the at least one expert will provide expert support to the agent.

27. The system of claim 26, wherein the identification module is to communicate in at least one of a parallel communication and a serial communication.

28. The system of claim 21, wherein the identification module is to identify the at least one expert includes to present the request for assistance to all experts in the expert group and to present the request for assistance to a predetermined number of experts in the expert group and to present the request for assistance to at least one expert based on preferences selected by an agent.

29. The system of claim 28, wherein the identification module to identify the at least one expert includes to accept the request for assistance from a single expert.

30. The system of claim 29, wherein the identification module is to notify and exclude other experts from accepting the request for assistance.

31. The system of claim 28, wherein the identification module is to identify the at least one expert by identifying a predetermined number of experts that accept the request for assistance.

32. The system of claim 21, wherein the connection module is to establish the immediate message connection to connect the agent to a customer interaction system, which in turn, is connected to the at least one expert.

33. The system of claim 32, wherein the customer interaction system is dropped from the immediate message connection.

34. The system of claim 21, wherein the expert group and the at least one expert and the agent are identified with instant message screennames.

35. The system of claim 21, wherein the immediate message includes an instant message and the immediate message connection includes an instant message connection and an immediate message service includes an instant message service and an immediate message session includes an instant message session and an immediate message metadata includes an instant message metadata.

36. The system of claim 21, wherein the customer query includes at least one of an email, a telephone call, a second immediate message, and a web chat that is established and processed by a customer interaction system.

37. The system of claim 35, further including an administrative module to log an immediate message session between the agent and the at least one expert in an immediate message log for subsequent search, wherein the immediate message session includes immediate message metadata and immediate messages.

38. The system of claim 36, wherein the administrative module to capture statistics on a plurality of immediate message sessions and to report the statistics to facilitate the management of the customer interaction system.

39. The method of claim 21, wherein the identification module to identify the at least one expert includes to identify the at least one expert based on the name of an expert that was selected by the agent.

40. The method of claim 21, wherein the identification module is to communicate at least one expert group to the agent based on expert groups associated with the agent.

41. A system to respond to a customer query received at a customer
interaction system, the system including:
a first means for communicating an expert group to an agent, the first means to further receive a selection from the agent that identifies the expert group, the selection triggering a first immediate message that requests assistance from the at least one expert group;
a second means for identifying at least one expert that is associated with the expert group; and
a third means for establishing an immediate message connection between the at least one expert and the agent, wherein the immediate message connection enables the exchange of immediate messages between the at least one expert and the agent so the agent may respond to the customer query.

42. A machine readable medium storing a set of instructions that, when executed by the machine, cause the machine to:
communicate at least one expert group to an agent;
receive a selection from the agent that identifies an expert group from the at least one expert group, the selection triggering a first immediate message that includes a request for assistance from the expert group;
identify at least one expert that is associated with the expert group; and
establish an immediate message connection between the at least one expert and the agent, wherein the immediate message connection enables the exchange of immediate messages between the at least one expert and the agent so the agent may respond to the customer query.

43. A method to respond to a customer query received at a customer interaction system, the method including:
communicating a choice of preferences to an agent;
receiving a selection of preferences from the agent, the selection of preferences triggering a first immediate message that includes a request for assistance from at least one expert;
identifying at least one expert based on the selection of preferences; and
establishing an immediate message connection between the at least one expert and the agent, wherein the immediate message connection enables the exchange of immediate messages between the at least one expert and the agent so the agent may respond to the customer query.

44. The method of claim 43, wherein the identifying the at least one expert includes using an immediate message service to monitor a status of the at least one expert.

45. The method of claim 44, wherein the identifying the at least one expert includes identifying the at least one expert if the status of the at least one expert permits an interruption.

46. A system to respond to a customer query received at a customer interaction system, the system including:
a communication module to communicate a choice of preferences to an agent, the communication module to further receive a selection of preferences from the agent, the selection of preferences triggering a first immediate message that includes a request for assistance from at least one expert;
an identification module to identify at least one expert based on the selection of preferences; and
a connection module to establish an immediate message connection between the at least one expert and the agent, wherein the immediate message connection enables the exchange of immediate messages between the at least one expert and the agent so the agent may respond to the customer query.

47. The system of claim 46, wherein the identification module utilizes an immediate message service to monitor a status of the at least one expert.

48. The system of claim 47, wherein the identification module is to identify the at least one expert if the status of the at least one expert permits an interruption.

49. A machine readable medium storing a set of instructions that, when executed by the machine, cause the machine to:
communicate a choice of preferences to an agent;
receive a selection of preferences from the agent, the selection of preferences triggering a first immediate message that includes a request for assistance from at least one expert;
identify at least one expert based on the selection of preferences; and
establish an immediate message connection between the at least one expert and the agent, wherein the immediate message connection enables the exchange of immediate messages between the at least one expert and the agent so the agent may respond to the customer query.

50. A method to respond to a requester query received at a customer interaction system, the method including:
communicating at least one expert group to a requester;
receiving a selection from the requester that identifies an expert group from the at least one expert group, the selection triggering a first immediate message that includes a request for assistance from the expert group;
identifying at least one expert that is associated with the expert group; and
establishing an immediate message connection between the at least one expert and the requester, wherein the immediate message connection enables the exchange of immediate messages between the at least one expert and the requester so the requester may receive a response to the requester query.

51. The method of claim 50, wherein the identifying the at least one expert includes using an immediate message service to monitor a status of the at least one expert.

52. The method of claim 51, wherein identifying the at least one expert includes identifying the at least one expert if the status of the at least one expert permits an interruption.

53. A system to respond to a requester query received at a customer interaction system, the system including:
a communication module to communicate at least one expert group to the requester, the communication module to further receive a selection from the agent that identifies an expert group from the at least one expert group, the selection triggering a first immediate message that includes a request for assistance from the expert group;
an identification module to identify at least one expert that is associated with the expert group; and
a connection module to establish an immediate message connection between the at least one expert and the requester, wherein the immediate message connection enables the exchange of immediate messages between the at least one expert and the requester so the agent may receive a response to the requester query.

54. The system of claim 53, wherein the identification module utilizes an immediate message service to monitor a status of the at least one expert.

55. The system of claim 54, wherein the identification module is to identify the at least one expert if the status of the at least one expert permits an interruption.

56. A machine readable medium storing a set of instructions that, when executed by the machine, cause the machine to:
communicate at least one expert group to a requester;
receive a selection from the requester that identifies an expert group from the at least one expert group, the selection triggering a first immediate message that includes a request for assistance from the expert group;
identify at least one expert that is associated with the expert group; and
establish an immediate message connection between the at least one expert and the requester, wherein the immediate message connection enables the exchange of immediate messages between the at least one expert and the requester so the requester may receive a response to the requester query.
